(19) United States
(12) Patent Application Publication
(10) Pub. No.: US 2008/0094495 A1
(43) Pub. Date: Apr. 24, 2008

(54) Solid-state image capturing device, method for driving the solid-state image capturing device, and electronic information device

(75) Inventors: Akinori Shikata, Kyoto (JP); Takehiko Ozumi, Nara (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 11/975,410

(22) Filed: Oct. 19, 2007

(30) Foreign Application Priority Data
Oct. 19, 2006 (JP) 2006-285261

(51) Int. Cl. H04N 5/335

(52) U.S. Cl. 348/314; 348/E05.091

(57) ABSTRACT

A solid-state image capturing device according to the present invention includes: a plurality of light receiving sections, arranged in a matrix in an image capturing region, for photoelectrically converting received light into signal electrical charges; signal readout sections for reading out the signal electrical charges from the light receiving sections; vertical transfer sections driven by n-phase drive (n≧2, k is an integer greater than or equal to 2) in order to transfer the signal electrical charges, which have been read out from the light receiving sections in a column direction, in a vertical direction, wherein first-layer electrodes and second-layer electrodes are arranged in an alternating manner, and n electrodes make up one set of electrodes; a horizontal transfer section for transferring the signal electrical charges, which have been transferred from the vertical transfer sections, in a horizontal direction, wherein the vertical transfer sections include first vertical transfer sections for transferring the signal electrical charges, which have been read out from the light receiving sections, in one direction or in an other direction and second vertical transfer sections for transferring the signal electrical charges in the one direction or the other direction with timings independent of those for the first vertical transfer sections.

This Nonprovisional application claims priority under 35 U.S.C. §119(a) on Patent Application No. 2006-285261 filed in Japan on Oct. 19, 2006, the entire contents of which are hereby incorporated by reference.

### BACKGROUND OF THE INVENTION

1. Field of the Invention

The present invention relates to: a solid-state image capturing device having a plurality of semiconductor devices as pixel sections for performing a photoelectrical conversion on image light from a subject and capturing an image of the subject; a method for driving the solid-state image capturing device; and an electronic information device (e.g., digital camera (digital video camera, digital still camera and the like), image input camera, scanner, facsimile, cell phone device equipped with camera and the like) using the solid-state image capturing device as an image input device for an image capturing section thereof.

2. Description of the Related Art

Recently, an image capturing device (e.g., digital camera) has been rapidly having a high image quality, and a solid-state image capturing device having one million or more pixels as the image capturing device, especially a CCD image sensor, has been widely used.

However, due to the reason that the CCD image sensor having one million or more pixels has a limited drive frequency characteristic, a lower power consumption is intended and the like, it has been becoming difficult to achieve a high image quality by simply increasing the speed of the drive frequency.

In order to address this problem, at present, a method is proposed in which a fast readout of signal electrical charges is achieved by proving a plurality of signal output paths.

As an example of the method described above, Reference 1 discloses a method of: dividing an image capturing region into two blocks (left and right); transferring signal electrical charges of each block to a respective horizontal transfer register; transferring the signal electrical charges from each block of left and right in the horizontal transfer register in a horizontal direction so as to be transferred in opposite directions; and reading out the signal electrical charges of the blocks from two respective signal output sections arranged on the left and right sides.

Reference 2 discloses a method of: providing horizontal transfer registers on both upper and lower sides of an image capturing region; transferring signal electrical charges in the odd-number columns to the horizontal transfer register on the lower side; and transferring signal electrical charges in the even-number columns to the horizontal transfer register on the upper side so as to read out the signal electrical charges.

Reference 3 discloses a method of controlling the direction for transferring signal electrical charges from vertical transfer registers in each column using two-layered gate electrodes.

Further, conventionally, as a driving method used in producing a moving picture on a liquid crystal monitor or the like (monitoring mode), a method of securing a readout speed by decimating the number of vertical lines and reducing a data amount is known.

Reference 1: Japanese Laid-Open Publication No. 3-224371

Reference 2: Japanese Laid-Open Publication No. 8-125158

Reference 3: Japanese Laid-Open Publication No. 2004-80690

### SUMMARY OF THE INVENTION

However, the conventional solid-state image capturing device described above having a plurality of signal output paths has the following problems.

The conventional solid-state image capturing devices disclosed in References 1 and 2 have a limited direction for transferring signal electrical charges from transfer registers. Therefore, it is difficult to set a drive timing having a high degree of freedom. The conventional solid-state image capturing device disclosed in Reference 3 for controlling the direction for transferring signal electrical charges from vertical transfer registers in each column using two-layered gate electrodes is capable of four-phase drive, but not capable of six-phase drive or eight-phase drive.

The present invention is intended to solve the conventional problems described above. The objective of the present invention is to provide: a solid-state image capturing device capable of controlling, in each column, the readout of signal electrical charges from light receiving sections to vertical transfer registers, the readout of the signal electrical charges from the vertical transfer registers to horizontal transfer registers, and the direction for transferring the signal electrical charges from the vertical transfer registers, using two-layered gate electrodes having a simple structure; and a method for driving the solid-state image capturing device; and an electronic information device using the solid-state image capturing device for an image capturing section thereof.

A solid-state image capturing device according to the present invention includes: a plurality of light receiving sections, arranged in a matrix in an image capturing region, for photoelectrically converting received light into signal electrical charges; signal readout sections for reading out the signal electrical charges from the light receiving sections; vertical transfer sections driven by n-phase drive (n≧2, k is an integer greater than or equal to 2) in order to transfer the signal electrical charges, which have been read out from the light receiving sections in a column direction, in a vertical direction, wherein first-layer electrodes and second-layer electrodes are arranged in an alternating manner, and n electrodes make up one set of electrodes; a horizontal transfer section for transferring the signal electrical charges, which have been transferred from the vertical transfer sections, in a horizontal direction, wherein the vertical transfer sections include first vertical transfer sections for transferring the signal electrical charges, which have been read out from the light receiving sections, in one direction or in an other direction and second vertical transfer sections for transferring the signal electrical charges in the one direction or the other direction with timings independent of those for the first vertical transfer sections, thereby the objective describe above being achieved.

Preferably, in a solid-state image capturing device according to the present invention, a plurality of columns of light receiving sections having signal electrical charges to be read out to the first vertical transfer sections and a plurality of columns of light receiving sections having signal electrical charges to be read out to the second vertical transfer sections are arranged, and a direction for transferring the signal electrical charges is controlled in each group of columns.

Still preferably, in a solid-state image capturing device according to the present invention, the first vertical transfer sections and the second vertical transfer sections are arranged in each column in an alternating manner.

Still preferably, in a solid-state image capturing device according to the present invention, the first vertical transfer sections and the second vertical transfer sections are arranged in every plurality of columns in an alternating manner.

Still preferably, in a solid-state image capturing device according to the present invention, the second-layer electrodes include first patterns for driving the first vertical transfer sections and second patterns for driving the second vertical transfer sections, and transfer control signals independent of each other are applied to the first patterns and the second patterns, respectively.

Still preferably, in a solid-state image capturing device according to the present invention, patterns of the first-layer electrodes are the same in a column direction, and first patterns and second patterns of the second-layer electrodes are different at the first vertical transfer sections and the second vertical transfer sections, respectively.

Still preferably, in a solid-state image capturing device according to the present invention, each of the first-layer electrodes is substantially strip-shaped and extends in a horizontal direction between adjacent light receiving sections of the plurality of light receiving sections, the first-layer electrode has patterns having a branched projection which extends in one of one direction and an other direction at each of the first vertical transfer sections and having a branched projection which extends in the other of the one direction and the other direction at each of the second vertical transfer sections, each of the second-layer electrodes is substantially strip-shaped and extends in the horizontal direction between adjacent light receiving sections of the plurality of light receiving sections, the second-layer electrode includes a first pattern which extends in the other of the one direction and the other direction at the first vertical transfer section and which partially overlaps each of the branched projections of the first-layer electrode, and a second pattern which extends in the one of the one direction and the other direction at the second vertical transfer section and which partially overlaps each of the branched projections of the first-layer electrode.

Still preferably, in a solid-state image capturing device according to the present invention, the first pattern is structured such that the width thereof is significantly narrower at the second vertical transfer section than at the first vertical transfer section so as not to influence a transfer of the signal electrical charges from the second vertical transfer section, and the second pattern is structured such that the width thereof is significantly narrower at the first vertical transfer section than at the second vertical transfer section so as not to influence a transfer of the signal electrical charges from the first vertical transfer section.

Still preferably, a solid-state image capturing device according to the present invention further includes: a plurality of first signal readout sections, connected to the second-layer electrodes, for reading out the signal electrical charges from the light receiving sections in a first group of columns to the first vertical transfer sections; and a plurality of second signal readout sections, connected to the second-layer electrodes, for reading out the signal electrical charges from the light receiving sections in a second group of columns other than the first group of columns to the second vertical transfer sections, wherein control signals independent of each other are applied to the signal readout sections, respectively, and a readout of the signal electrical charges from the plurality of light receiving sections to the vertical transfer sections is controlled in each group of columns.

Still preferably, in a solid-state image capturing device according to the present invention, the horizontal transfer section is arranged at one or both of one end and an other end of the image capturing region.

Still preferably, in a solid-state image capturing device according to the present invention, first-layer electrodes and second layer electrodes are repeatedly arranged in the horizontal transfer section.

Still preferably, in a solid-state image capturing device according to the present invention, the first vertical transfer section and the second vertical transfer section each are arranged in each column in accordance with functions of the light receiving sections.

A solid-state image capturing device drive method according to the present invention for driving the solid-state image capturing device according to the present invention includes: applying transfer control signals with same or different timings to the second-layer electrodes at the first vertical transfer sections and the second vertical transfer sections in order to control a transfer of signal electrical charges from the first vertical transfer sections and the second vertical transfer sections to the horizontal transfer section in each group of columns, thereby the objective described above being achieved.

A solid-state image capturing device drive method according to the present invention for driving the solid-state image capturing device according to the present invention includes: applying readout control signals to only one of the first signal readout sections and the second signal readout sections such that a readout of signal electrical charges from the light receiving sections to the first vertical transfer sections or the second vertical transfer sections is controlled in each group of columns and data in columns of the first vertical transfer sections or in columns of the second vertical transfer sections is decimated, thereby the objective described above being achieved.

A solid-state image capturing device drive method according to the present invention for driving the solid-state image capturing device according to the present invention includes: applying readout control signals to the first signal readout sections and the second signal readout sections with same or different timings such that a readout of signal electrical charges from the plurality of light receiving sections to the first vertical transfer sections and the second vertical transfer sections is controlled in each group of columns and data having a wide dynamic range is created by performing exposures on the plurality of light receiving sections in accordance with light portions and dark portions thereon and by combining two pieces of data, thereby the objective described above being achieved.

An electronic information device according to the present invention uses the solid-state image capturing device according to the present invention for an image capturing section thereof, thereby the objective described above being achieved.

Hereinafter, the functions of the present invention having the structures described above will be described.

According to the present invention, in a solid-state image capturing device including: a plurality of light receiving sections arranged in a matrix in an image capturing region; vertical transfer sections operated by n-phase drive (n≧2, k is an integer greater than or equal to 2) in order to transfer signal electrical charges, which have been read out from the light receiving sections, in a vertical direction, wherein first-layer gate electrodes and second-layer gate electrodes are arranged in an alternating manner, and n gate electrodes make up one set of gate electrodes; and a horizontal transfer section in order to transfer the transferred signal electrical charges in a horizontal direction, wherein first-layer electrodes and second-layer electrodes are repeatedly arranged in an alternating manner, columns of first vertical transfer sections for transferring the signal electrical charges read out from the light receiving sections, for example, in the upward direction or in the downward direction and columns of second vertical transfer sections for transferring the signal electrical charges in the upward direction or the downward direction with timings independent of those for the first vertical transfer sections are provided. The second vertical transfer sections include the second-layer gate electrodes with patterns that are different from the patterns of the second-layer gate electrodes at the first vertical transfer sections. By independently applying transfer control signals to the second-layer gate electrodes at the first vertical transfer sections and the second-layer gate electrodes at the second vertical transfer sections, it is possible to control, in each of the two groups of columns, the transfer direction for the vertical transfer sections and the readout of the signal electrical charges from the vertical transfer sections to the horizontal transfer section.

In addition, the solid-state image capturing device according to the present invention includes first signal readout sections (first transfer gates) connected to the second-layer gate electrodes of the first vertical transfer sections, and second signal readout sections (second transfer gates) connected to the second-layer gate electrodes of the second vertical transfer sections. By independently applying readout control signals to the first transfer gates and the second transfer gates, it is possible to control, in each of the two groups of columns, the readout of signal electrical charges from the light receiving sections to the first vertical transfer sections and the second vertical transfer sections.

For example, by applying readout control signals to only one of the first transfer gates and the second transfer gates, it is possible to implement a fast readout of signal electrical charges by controlling, in each of the two groups of columns, the readout of signal electrical charges from the light receiving sections to the first vertical transfer sections and the second vertical transfer sections, and by decimating data in the horizontal direction. In addition, by applying readout control signals to the first transfer gates and the second transfer gates with the same or different timings, it is possible to control, in each of the two groups of columns, the readout of signal electrical charges from the light receiving sections to the first vertical transfer sections and the second vertical transfer sections, and also possible to create data having a wide dynamic range by performing exposures on the light receiving sections in accordance with light portions and dark portions thereon and by combining two pieces of data.

In this manner, it is possible to control, in each column, the readout of signal electrical charges from light receiving sections to vertical transfer sections, the readout of the signal electrical charges from the vertical transfer sections to a horizontal transfer section, and the direction for transferring the signal electrical charges from the vertical transfer sections, using two-layered gate electrodes having a simple structure.

As described above, according to the present invention, with the first vertical transfer sections and the second vertical transfer sections which can apply control signals only to the second-layer gate electrodes with different timings using two-layered gate electrodes having a simple structure, it is possible to control a drive timing in each group of columns. As such, it is possible to control the time for reading signal electrical charges from the vertical transfer sections to the horizontal transfer section in each group of columns and the direction for transferring the signal electrical charges from the vertical transfer sections.

In addition, with the first signal readout sections and the second signal readout sections connected to the second-layer gate electrodes such that readouts from each of the light receiving sections to each of the vertical transfer sections are performed with timings independent of each other, a readout timing is controlled in each group of columns. As such, it is possible to control the time for reading out signal electrical charges from the light receiving sections to the vertical transfer sections in each group of columns.

Further, in n-phase drive (e.g., four-phase drive, six-phase drive), in which n gate electrodes make up one set of gate electrodes and the n gate electrodes are driven, it is possible, without limiting the number ton, to control the time for reading out from the vertical transfer sections to the horizontal transfer section in each group of columns, the direction for transferring signal electrical charges from the vertical transfer sections and the time for reading out signal electrical charges from the light receiving sections to the vertical transfer sections.

These and other advantages of the present invention will become apparent to those skilled in the art upon reading and understanding the following detailed description with reference to the accompanying figures.

### BRIEF DESCRIPTION OF THE DRAWINGS

FIG. 1 is a block diagram schematically showing an exemplary essential plane structure of a CCD image sensor as a solid-state image capturing device according to an embodiment of the present invention.

FIG. 2 is a block diagram schematically showing another exemplary essential plane structure of a CCD image sensor as a solid-state image capturing device according to the embodiment of the present invention.

FIG. 3 is a plane view showing an example of the gate electrode structure in the vertical transfer registers of the solid-state image capturing device in FIG. 1 or FIG. 2, and the vertical transfer registers can be controlled in each group of columns.

Portion (a) of FIG. 4 and Portion (b) of FIG. 4 are longitudinal cross-sectional views showing cross-sectional gate electrode structure cut at line A-A′ and line B-B′, respectively, shown in FIG. 3.

FIG. 5 is a timing diagram showing drive timings when signal electrical charges are transferred in opposite directions in a four-phase drive method for the solid state image capturing device according to the embodiment of the present invention.

Portion (a) of FIG. 6 and Portion (b) of FIG. 6 each are a potential diagram for describing a state of potentials in the vertical transfer registers when signal electrical charges are transferred in opposite directions in the four-phase drive method for the solid-state image capturing device in FIG. 5.

FIG. 7 is a timing diagram showing drive timings when signal electrical charges are transferred in the same direction in each column in the four-phase drive method for the solid state image capturing device according to the embodiment of the present invention.

Portion (a) of FIG. 8 and Portion (b) of FIG. 8 each are a potential diagram for describing a state of potentials in the vertical transfer registers when signal electrical charges are transferred in the same direction in each column in the four-phase drive method for the solid-state image capturing device in FIG. 7.

FIG. 9 is a timing diagram showing drive timings when signal electrical charges are transferred in opposite directions in a six-phase drive method for the solid state image capturing device according to the embodiment of the present invention.

Portion (a) of FIG. 10 and Portion (b) of FIG. 10 each are a potential diagram for describing a state of potentials in the vertical transfer registers when signal electrical charges are transferred in opposite directions in the six-phase drive method for the solid-state image capturing device in FIG. 9.

FIG. 11 is a timing diagram showing drive timings when signal electrical charges are transferred in the same direction in each column in the six-phase drive method for the solid state image capturing device according to the embodiment of the present invention.

Portion (a) of FIG. 12 and Portion (b) of FIG. 12 each are a potential diagram for describing a state of potentials in the vertical transfer registers when signal electrical charges are transferred in the same direction in each column in the six-phase drive method for the solid-state image capturing device in FIG. 11.

FIG. 13 is a timing diagram showing drive timings when signal electrical charges are transferred in opposite directions in an eight-phase drive method for the solid state image capturing device according to the embodiment of the present invention.

Portion (a) of FIG. 14 and Portion (b) of FIG. 14 each are a potential diagram for describing a state of potentials in the vertical transfer registers when signal electrical charges are transferred in opposite directions in the eight-phase drive method for the solid-state image capturing device in FIG. 13.

FIG. 15 is a timing diagram showing drive timings when signal electrical charges are transferred in the same direction in each column in the eight-phase drive method for the solid state image capturing device according to the embodiment of the present invention.

Portion (a) of FIG. 16 and Portion (b) of FIG. 16 each are a potential diagram for describing a state of potentials in the vertical transfer registers when signal electrical charges are transferred in the same direction in each column in the eight-phase drive method for the solid-state image capturing device in FIG. 15.

FIG. 17 is a plane view showing another example of the gate electrode structure of the vertical transfer registers of the solid-state image capturing device in FIG. 1 or FIG. 2.

Portion (a) of FIG. 18 to Portion (e) of FIG. 18 each are a diagram for describing a method for a fast readout of signal electrical charges by decimating data in the solid-state image capturing device in FIG. 17.

Portion (a) of FIG. 19 to Portion (d) of FIG. 19 is a diagram for describing a method for driving the light receiving sections at light portions and dark portions in the solid-state image capturing device in FIG. 17.

FIG. 20 is a timing diagram for describing drive timings for implementing a method for driving the light receiving sections at the light potions and the dark portions in the solid-state image capturing device in FIG. 17.

FIG. 21 is a block diagram showing an exemplary schematic structure of an electronic information device using the solid-state image capturing device according to the present invention for an image capturing section thereof.

1 light receiving section (photodiode)
2 transfer gate (signal readout section)
2a first transfer gate (first signal readout section)
2b second transfer gate (second signal readout section)
3 vertical transfer register (vertical transfer section)
3a first vertical transfer register (first vertical transfer section)
3b second vertical transfer register (second vertical transfer section)
4, 4a, 4b horizontal transfer register (horizontal transfer section)
5 output amplifier (signal output section)
6 first-layer gate electrode
7 second-layer gate electrode
7a second-layer gate electrode of the first vertical transfer register
7b second-layer gate electrode of the second vertical transfer register
10, 11 CCD image sensor (solid-state image device)
100 electronic information device
101 memory section
102 display section
103 communication section
104 image output section

### DESCRIPTION OF THE PREFERRED EMBODIMENTS

Hereinafter, cases will be described in detail with reference to the accompanying drawings in which embodiments of a solid-state image capturing device and a method for driving the solid-state image capturing device according to the present invention are applied to an interline transfer CCD image sensor.

(Layout Structure of an Essential Part of a Solid-State Image Capturing Device)

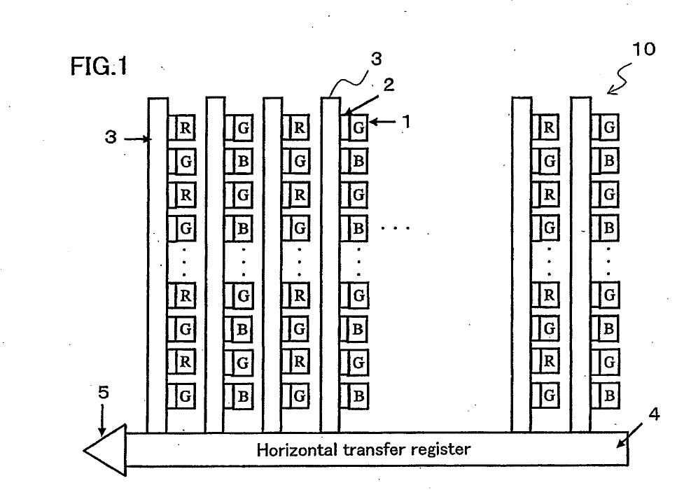

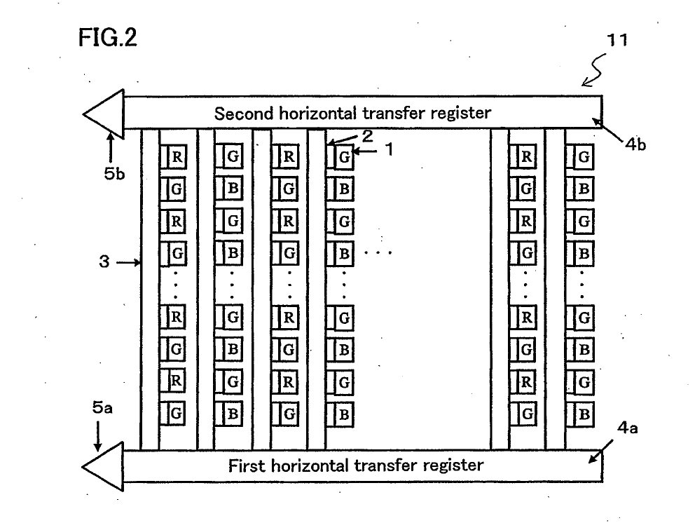

First, the layout structure of an essential part of a solid-state image capturing device according to an embodiment of the present invention will be described with reference to FIG. 1 and FIG. 2.

FIG. 1 is a block diagram schematically showing an exemplary essential plane structure of a CCD image sensor 10 as the solid-state image capturing device according to the embodiment of the present invention.

In FIG. 1, the CCD image sensor 10 as the solid-state image capturing device according to the present embodiment includes: a plurality of light receiving sections (photodiodes) 1, arranged in two dimensions in an image capturing region, for photoelectrically converting received subject light into signal electrical charges; transfer gates 2 as signal readout sections capable of controlling, in each group of columns, the readout of the signal electrical charges from the light receiving sections 1 as pixel sections to vertical transfer sections; vertical transfer registers 3 as vertical transfer sections capable of controlling, in each group of columns, the transfer of the signal electrical charges read out from the light receiving sections 1 as pixel sections in a vertical direction; a horizontal transfer register 4 as a horizontal transfer section capable of controlling, in a horizontal direction, the transfer of the signal electrical charges transferred from the vertical transfer registers 3; and an output amplifier 5 as a signal output section, provided at an end of the horizontal transfer register 4 in the horizontal direction, for detecting the signal electrical charges transferred in the horizontal direction so as to obtain image capturing signals. A color filter having an RGB Bayer array is arranged on each light receiving section 1, and a color image capturing is implemented.

The vertical transfer registers 3 have a two-layered gate structure in which first-layer gate electrodes (not shown) and second-layer gate electrodes (not shown) are arranged in an alternating manner, and n gate electrodes make up one set of gate electrodes and the n gate electrodes are driven by n-phase drive (n≧2 k, k is an integer greater than or equal to 2).

In addition, the horizontal transfer register 4 is provided at one end (e.g., at the lower portion) of an image capturing region, and first-layer gate electrodes (not shown) and second-layer gate electrodes (not shown) are repeatedly arranged in the horizontal transfer register 4 in an alternating manner.

FIG. 2 is a block diagram schematically showing another exemplary essential plane structure of a CCD image sensor 11 as a solid-state image capturing device according to the embodiment of the present invention.

In FIG. 2, the COD image sensor 11 as the solid-state image capturing device according to the present embodiment, similar to the solid-state image capturing device 10, includes: a plurality of light receiving sections (photodiodes) 1, arranged in two dimensions in an image capturing region, for photoelectrically converting received subject light into signal electrical charges; transfer gates 2 as signal readout sections capable of controlling, in each group of columns, the readout of the signal electrical charges from the light receiving sections 1 as pixel sections to vertical transfer sections; vertical transfer registers 3 as vertical transfer sections capable of controlling, in each group of columns, the transfer of the signal electrical charges read out from the light receiving sections 1 as pixel sections in a vertical direction; horizontal transfer registers 4a and 4b as horizontal transfer sections capable of controlling, in a horizontal direction, the transfer of the signal electrical charges transferred from the vertical transfer registers 3; and output amplifiers 5a and 5b as signal output sections, provided at ends of the respective horizontal transfer registers 4a and 4b in the horizontal direction, for detecting the signal electrical charges transferred in the horizontal direction so as to obtain image capturing signals. A color filter having an RGB Bayer array is arranged on each light receiving section 1, and a color image capturing is implemented.

The vertical transfer registers 3, similar to the case of the solid-state image capturing device 10, have a two-layered gate structure in which first-layer gate electrodes (not shown) and second-layer gate electrodes (not shown) are arranged in an alternating manner, and n gate electrodes make up one set of gate electrodes and the n gate electrodes are driven by n-phase drive (n≧2 k, k is an integer greater than or equal to 2).

In addition, the horizontal transfer registers 4a and 4b are provided at one end (e.g., at the lower portion) and at another end (e.g., at the upper portion) of an image capturing region, and first-layer gate electrodes (not shown) and second-layer gate electrodes (not shown) are repeatedly arranged in the horizontal transfer registers 4a and 4b in an alternating manner.

(Gate Electrode Structure in the Vertical Transfer Registers 3)

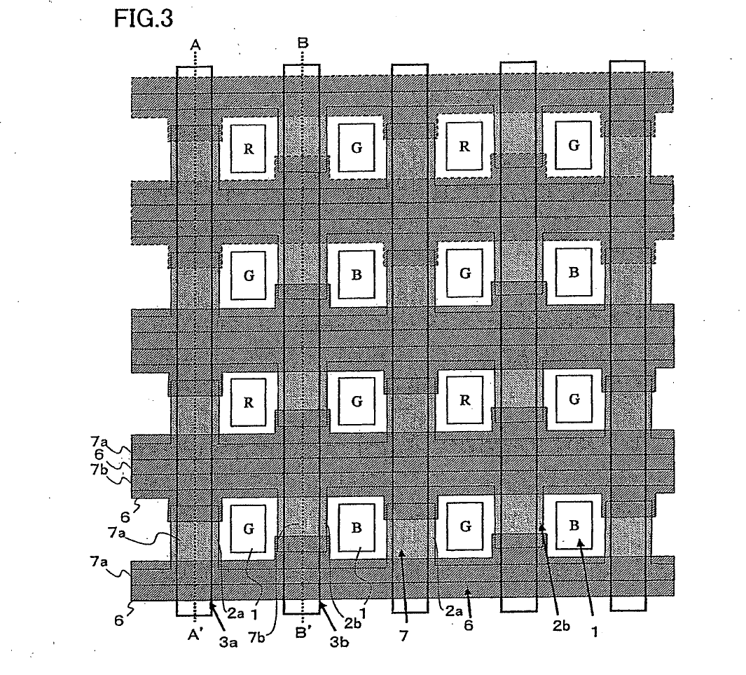

Next, the gate electrode structure in the vertical transfer registers 3 according to the present embodiment will be described with reference to FIG. 3 and FIG. 4.

FIG. 3 is a plane view of the gate electrode structure in the vertical transfer registers 3 of the solid-state image capturing device in FIG. 1 or FIG. 2. The vertical transfer registers 3 can be controlled in each group of columns. Portion (a) of FIG. 4 and Portion (b) of FIG. 4 each are a longitudinal cross-sectional view showing a cross-sectional gate electrode structure cut at line A-A′ and line B-B′, respectively, shown in FIG. 3. Herein, a case will be described in which vertical transfer registers in the odd-number columns are regarded as first vertical transfer registers 3a, and vertical transfer registers in the even-number columns are regarded as second vertical transfer registers 3b, the first vertical transfer registers 3a and the second vertical transfer registers 3b are arranged in each column in an alternating manner, and they are separately controlled.

The patterns of first-layer gate electrodes 6 which are perpendicular to the first vertical transfer registers 3a and the second vertical transfer registers 3b are substantially the same. In FIG. 3, a first-layer gate electrode 6 is substantially strip-shaped and it extends in a horizontal direction between adjacent light receiving sections 1. The first-layer gate electrode 6 has a branched projection extending in one direction (e.g., in the downward direction) at each of the first vertical transfer registers 3a and has a branched projection extending in an other direction (e.g., in the upward direction) at each of the second vertical transfer registers 3b. For example, when the first vertical transfer registers 3a and the second vertical transfer registers 3b are driven by four-phase drive, control signals φV2 and control signals φV4 are applied to the first-layer gate electrodes 6 at the first vertical transfer registers 3a and the second vertical transfer registers 3b in each column in an alternating manner, as shown in Portion (a) of FIG. 4 and Portion (b) of FIG. 4.

In addition, the patterns of second-layer gate electrodes 7a and 7b which are perpendicular to the first vertical transfer registers 3a and the second vertical transfer registers 3b are two types, which are different from each other. In FIG. 3, a second-layer gate electrode 7 as a second-layer electrode is substantially strip-shaped, and it extends in a horizontal direction between adjacent light receiving sections 1. The second-layer gate electrode 7 includes two types of second-layer gate electrodes 7a and 7b: one is a second-layer gate electrode 7a which has a pattern of having a projection extending in the upward direction at the first vertical transfer register 3a and which partially overlaps each of the branched projections of the first-layer gate electrode 6; and the other is a second-layer gate electrode 7b which has a pattern of having a projection extending in the downward direction at the second vertical transfer register 3b and which partially overlaps each of the branched projections of the first-layer gate electrode 6. Transfer control signals independent of each other are applied to the second-layer gate electrodes 7a and 7b, respectively. For example, when the first vertical transfer registers 3a and the second vertical transfer registers 3b are driven by four-phase drive, control signals φV1A and control signals φV3A are applied from a control signal generation circuit (not shown) to the second-layer gate electrodes 7a at the first vertical transfer registers 3a in each column in an alternating manner, as shown in Portion (a) of FIG. 4. In addition, control signals φV1B and control signals φV3B are applied from the control signal generation circuit (not shown) to the second-layer gate electrodes 7b at the second vertical transfer registers 3b in each column in an alternating manner, as shown in Portion (b) of FIG. 4.

As described above, a plurality of columns of light receiving sections 1 having signal electrical charges to be read out to the first vertical transfer sections 3a and a plurality of columns of light receiving sections 1 having signal electrical charges to be read out to the second vertical transfer sections 3b are arranged, and the direction for transferring and the time for transferring signal electrical charges can be controlled in each group of columns.

Further, as a shape of a pattern for allowing an independent transfer control in each group of columns, the pattern of the second-layer gate electrode 7a is structured such that the width thereof is significantly narrower at the second vertical transfer register 3b than at the first vertical transfer register 3a so as not to influence a transfer of signal electrical charges from the second vertical transfer register 3b. The pattern of the second-layer gate electrode 7b is structured such that the width thereof is significantly narrower at the first vertical transfer register 3a than at the second vertical transfer register 3b so as not to influence a transfer of signal electrical charges from the first vertical transfer register 3a.

As shown in the electrode structure shown in FIG. 3 and FIG. 4, a first-layer gate electrode 6, a second-layer gate electrode 7a, a first-layer gate electrode 6 and a second layer gate electrode 7a are arranged at the first vertical transfer registers 3a in the downward direction, which are provided in the odd-number columns, and a first-layer gate electrode 6, a second-layer gate electrode 7b, a first-layer gate electrode 6 and a second layer gate electrode 7b are arranged at the second vertical transfer registers 3b in the upward direction, which are provided in the even-number columns. Control signals φV1A and control signals φV3A are applied in the odd-number columns with different timings. Control signals φV1B and control signals φV3B are applied in the even-number columns with different timings. Therefore, it is possible to control the timings for transferring signal electrical charges in the odd-number columns and in the even-number columns in an independent manner.

In addition, a drive timing form-phase drive (e.g., six-phase drive and eight-phase drive) can be controlled in a manner similar to that of the four-phase drive. In any case, the patterns of the first-layer gate electrode 6 having branched projections in the upward and downward directions are the same at the first vertical transfer register 3a and the second vertical transfer register 3b. The patterns of the second-layer gate electrodes 7a and 7b are two types, which are different at the first vertical transfer register 3a and the second-layer transfer register 3b.

For example, when the first vertical transfer registers 3a and the second vertical transfer registers 3b are driven by six-phase drive, control signals φV2, control signals φV4 and control signals φV6 are applied to the first-layer gate electrodes 6 at the first vertical transfer registers 3a and the second vertical transfer registers 3b in each column in an alternating manner. This is repeatedly performed. In addition, control signals φV1A, control signals φV3A and control signals φV5A are applied to the second-layer gate electrodes 7a at the first vertical transfer registers 3a in each column in an alternating manner, and control signals φV1B, control signals φV3B and control signals φV5B are applied to the second-layer gate electrodes 7b at the second vertical transfer registers 3b in each column in an alternating manner. This is repeatedly performed.

In addition, for example, when the first vertical transfer registers 3a and the second vertical transfer registers 3b are driven by eight-phase drive, control signals φV2, control signals φV4, control signals φV6 and control signals φV8 are applied to the first-layer gate electrodes 6 at the first vertical transfer registers 3a and the second vertical transfer registers 3b in each column in an alternating manner. This is repeatedly performed. In addition, control signals φV1A, control signals φV3A, control signals φV5A and control signals φV7A are applied to the second-layer gate electrodes 7a at the first vertical transfer registers 3a in each column in an alternating manner, and control signals φV1B, control signals φV3B, control signals φV5B and control signals φV7B are applied to the second-layer gate electrodes 7b at the second vertical transfer registers 3b in each column in an alternating manner. This is repeatedly performed.

A first transfer gate group as transfer gates 2a for reading out signal electrical charges from the light receiving sections 1 to the first vertical transfer register 3a is connected (connected in a circuit) to the second-layer gate electrodes 7a at the first vertical transfer registers 3a. Herein, the transfer gates 2a are used as a part of the second-layer gate electrodes 7a. A second transfer gate group as transfer gates 2b for reading out signal electrical charges from the light receiving sections 1 to the second vertical transfer register 3b is connected (connected in a circuit) to the second-layer gate electrodes 7b at the second vertical transfer registers 3b. Herein, the transfer gates 2b are used as a part of the second-layer gate electrodes 7b. Readout control signals independent of each other are applied to the transfer gates 2a and 2b, respectively, and the readout of signal electrical charges from the light receiving sections 1 to the vertical transfer registers 3a and 3b is controlled in each group of columns.

Next, a method for driving the solid-state image capturing device according to the present embodiment will be described. Herein, to make the description brief, a state of transferring signal electrical charges in the first vertical transfer registers 3a and the second vertical transfer registers 3b shown in FIG. 3 will be described.

(Four-Phase Drive Method in Different Vertical Transfer Directions)

First, a four-phase drive method in the upward and downward vertical transfer directions will be described.

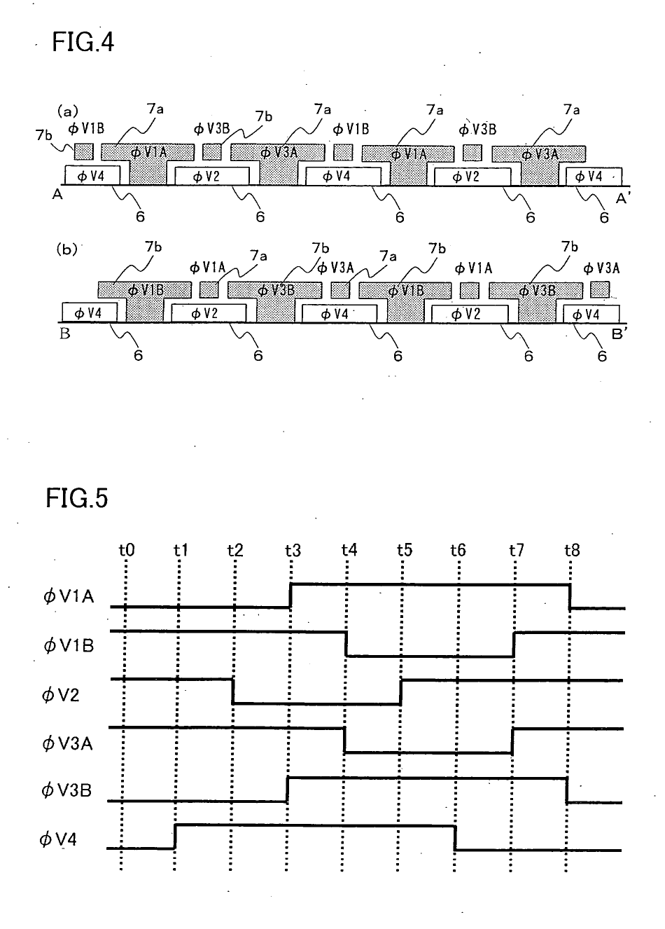

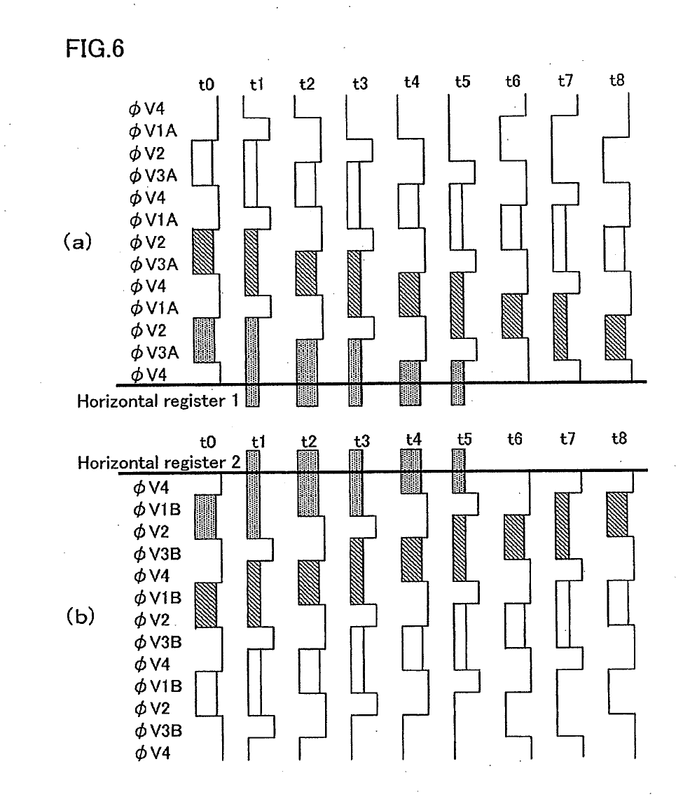

A case will be described with reference to FIG. 5 and FIG. 6 in which transfer control signals are applied with different timings to the second-layer gate electrodes 7a and 7b at the first vertical transfer registers 3a and the second vertical transfer registers 3b in order to control the transferring of signal electrical charges by four-phase drive from the first vertical transfer registers 3a and the second vertical transfer registers 3b to the horizontal transfer register 4a and the horizontal transfer register 4b in opposite directions in each group of columns (in each column).

FIG. 5 is a timing diagram showing drive timings when signal electrical charges are read out from vertical transfer registers to horizontal transfer registers in a four-phase drive method for the solid state image capturing device according to the embodiment of the present invention, that is, when signal electrical charges are read out to the horizontal transfer register 4a provided at the lower portion of an image capturing region in columns of the first vertical transfer registers 3a and signal electrical charges are read out to the horizontal transfer register 4b provided at the upper portion of the image capturing region in columns of the second vertical transfer registers 3b.

Portion (a) of FIG. 6 and Portion (b) of FIG. 6 each are a potential diagram showing a state of potentials in the first vertical transfer registers 3a and the second vertical transfer registers 3b when signal electrical charges are transferred in opposite directions in the four-phase drive method for the solid-state image capturing device in FIG. 5. Herein, a transfer cycle of one stage of the vertical transfer registers consists of times t1 to t8.

As shown in FIG. 5, first, at time t0, control signals φV2 and control signals φV4, which are applied to the first-layer gate electrodes 6 at the first vertical transfer registers 3a and the second vertical transfer registers 3b in an alternating manner, are at high level and at low level, respectively. In addition, control signals φV1A and control signals φV3A, which are applied to the second-layer gate electrodes 7a at the first vertical transfer registers 3a in an alternating manner, are at low level and at high level, respectively. Further, control signals φV1B and control signals φV3B, which are applied to the second-layer gate electrodes 7b at the second vertical transfer registers 3b in an alternating manner, are at high level and at low level, respectively.

Next, at time t1, control signals φV4, which are applied to the first-layer gate electrodes 6 at the first vertical transfer registers 3a and the second vertical transfer registers 3b, are turned to high.

At time t2, control signals φV2, which are applied to the first-layer gate electrodes 6 at the first vertical transfer registers 3a and the second vertical transfer registers 3b, are turned to low.

At time t3, control signals φV1A, which are applied to the second-layer gate electrodes 7a at the first vertical transfer registers 3a, are turned to high, and control signals φV3B, which are applied to the second-layer gate electrodes 7b at the second vertical transfer registers 3b, are turned to high.

At time t4, control signals φV3A, which are applied to the second-layer gate electrodes 7a at the first vertical transfer registers 3a, are turned to low, and control signals φV1B, which are applied to the second-layer gate electrodes 7b at the second vertical transfer registers 3b, are turned to low.

At time t5, control signals φV2, which are applied to the first-layer gate electrodes 6 at the first vertical transfer registers 3a and the second vertical transfer registers 3b, are turned to high.

At time t6, control signals φV4, which are applied to the first-layer gate electrodes 6 at the first vertical transfer registers 3a and the second vertical transfer registers 3b, are turned to low.

At time t7, control signals φV3A, which are applied to the second-layer gate electrodes 7a at the first vertical transfer registers 3a, are turned to high, and control signals φV1B, which are applied to the second-layer gate electrodes 7b at the second vertical transfer registers 3b, are turned to high.

At time t8, control signals φV1A, which are applied to the second-layer gate electrodes 7a at the first vertical transfer registers 3a, are turned to low, and control signals φV3B, which are applied to the second-layer gate electrodes 7b at the second vertical transfer registers 3b, are turned to low.

In this manner, control signals φV1A and control signals φV3A, and control signals φV1B and control signals V3B are applied with different timings to the second-layer gate electrodes 7a at the first vertical transfer registers 3a and the second-layer gate electrodes 7b at the second vertical transfer registers 3b. As such, in the columns of the first vertical transfer registers 3a, potentials are shifted downward in the vertical direction, and thus signal electrical charges are transferred to the horizontal transfer register 4a provided at the lower portion of the image capturing region, as shown in Portion (a) of FIG. 6. In addition, in the columns of the second vertical transfer registers 3b, potentials are shifted upward in the vertical direction, and thus signal electrical charges are transferred to the horizontal transfer register 4b provided at the upper portion of the image capturing region, as shown in Portion (b) of FIG. 6. The transfers of the signal electrical charges to the horizontal transfer registers 4a and 4b start at time t1 and end at time t8 at the vertical transfer registers 3a and 3b, at the same time.

(Four-Phase Drive Method in the Same Vertical Transfer Direction)

Next, a four-phase drive method in the same vertical transfer direction will be described.

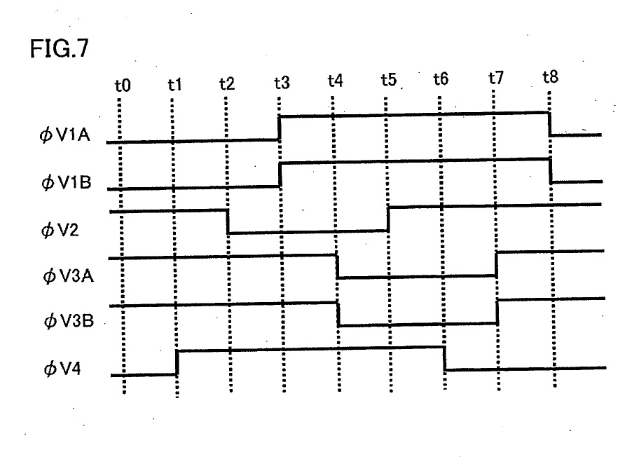

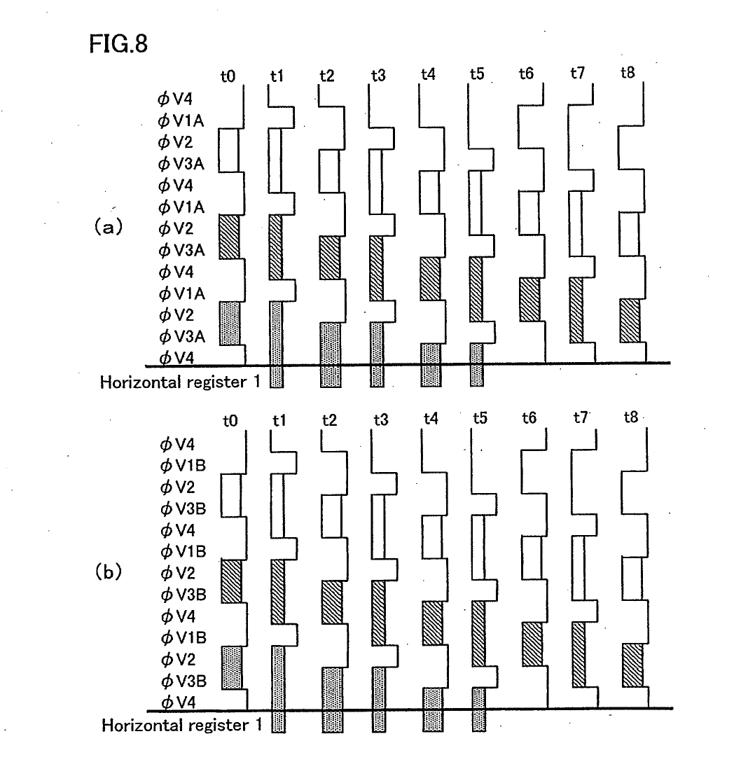

A case will be described with reference to FIG. 7 and FIG. 8 in which transfer control signals are applied with the same timings to the second-layer gate electrodes 7a and 7b at the first vertical transfer registers 3a and the second vertical transfer registers 3b in order to control the transfer of signal electrical charges by four-phase drive from the first vertical transfer registers 3a and the second vertical transfer registers 3b to the horizontal transfer register 4a (or 4b) in the same direction in each group of columns (in each column). A description herein will be made regarding the transfer of signal electrical charges to the horizontal transfer register 4a in FIG. 2 or the horizontal transfer register 4 in FIG. 1, each of which is provided at the lower portion of an image capturing region. Alternatively, signal electrical charges can be transferred to the horizontal transfer register 4b in FIG. 2, which is provided at the upper portion of the image capturing region.

FIG. 7 is a timing diagram showing drive timings when signal electrical charges are read out from vertical transfer registers to horizontal transfer registers in a four-phase drive method for the solid state image capturing device according to the embodiment of the present invention, that is, when signal electrical charges are read out to the horizontal transfer register 4a in FIG. 2 (or the horizontal transfer register 4 in FIG. 1) provided at the lower portion of an image capturing region in columns of both the first vertical transfer registers 3a and the second vertical transfer registers 3b.

Portion (a) of FIG. 8 and Portion (b) of FIG. 8 each are a potential diagram showing a state of potentials in the first vertical transfer registers 3a and the second vertical transfer registers 3b when signal electrical charges are transferred in the same direction in each column in the four-phase drive method for the solid-state image capturing device in FIG. 7. Herein, a transfer cycle of one stage of the vertical transfer registers consists of times t1 to t8.

As shown in FIG. 7, first, at time t0, control signals φV2 and control signals φV4, which are applied to the first-layer gate electrodes 6 at the first vertical transfer registers 3a and the second vertical transfer registers 3b in an alternating manner, are at high level and at low level, respectively. In addition, control signals φV1A and control signals φV3A, which are applied to the second-layer gate electrodes 7a at the first vertical transfer registers 3a in an alternating manner, are at low level and at high level, respectively. Further, control signals φV1B and control signals φV3B, which are applied to the second-layer gate electrodes 7b at the second vertical transfer registers 3b in an alternating manner, are at low level and at high level, respectively.

Next, at time t1, control signals φV4, which are applied to the first-layer gate electrodes 6 at the first vertical transfer registers 3a and the second vertical transfer registers 3b, are turned to high.

At time t2, control signals φV2, which are applied to the first-layer gate electrodes 6 at the first vertical transfer registers 3a and the second vertical transfer registers 3b, are turned to low.

At time t3, control signals φV1A, which are applied to the second-layer gate electrodes 7a at the first vertical transfer registers 3a, are turned to high, and control signals φV1B, which are applied to the second-layer gate electrodes 7b at the second vertical transfer registers 3b, are turned to high.

At time t4, control signals φV3A, which are applied to the second-layer gate electrodes 7a at the first vertical transfer registers 3a, are turned to low, and control signals φV3B, which are applied to the second-layer gate electrodes 7b at the second vertical transfer registers 3b, are turned to low.

At time t5, control signals φV2, which are applied to the first-layer gate electrodes 6 at the first vertical transfer registers 3a and the second vertical transfer registers 3b, are turned to high.

At time t6, control signals φV4, which are applied to the first-layer gate electrodes 6 at the first vertical transfer registers 3a and the second vertical transfer registers 3b, are turned to low.

At time t7, control signals φV3A, which are applied to the second-layer gate electrodes 7a at the first vertical transfer registers 3a, are turned high, and control signals φV3B, which are applied to the second-layer gate electrodes 7b at the second vertical transfer, registers 3b, are turned to high.

At time t8, control signals φV1A, which are applied to the second-layer gate electrodes 7a at the first vertical transfer registers 3a, are turned to low, and control signals φV1B, which are applied to the second-layer gate electrodes 7b at the second vertical transfer registers 3b, are turned to low.

In this manner, control signals φV1A and control signals φV3A, and control signals φV1B and control signals φV3B are applied with the same timings to the second-layer gate electrodes 7a at the first vertical transfer registers 3a and the second-layer gate electrodes 7b at the second vertical transfer registers 3b. As such, in the columns of both the first vertical transfer registers 3a and the second vertical transfer registers 3b, potentials are shifted downward in the vertical direction, and thus signal electrical charges are transferred to the horizontal transfer register 4 (or 4a) provided at the lower portion of the image capturing region, as shown in Portion (a) of FIG. 8 and Portion (b) of FIG. 8. The transfers of the signal electrical charges to the horizontal transfer register 4 (or 4a) start at time t1 and end at time t8 at the vertical transfer registers 3a and 3b, at the same time.

Further, at times t0 to t4 shown in FIG. 7, timings for applying control signals φV1A and control signals φV3A, and control signals φV1B and control signals φV3B are changed, and thus a time difference is provided for reading out signal electrical charges from the first vertical transfer registers 3a and the second vertical transfer registers 3b to the horizontal transfer register 4a. As such, a readout can be performed in each group of columns. In this manner, it is possible to control the direction for transferring as well as the time for transferring (transfer timing) signal electrical charges in each group of columns.

(Six-Phase Drive Method in Different Vertical Transfer Directions)

Next, a six-phase drive method in different vertical transfer directions will be described.

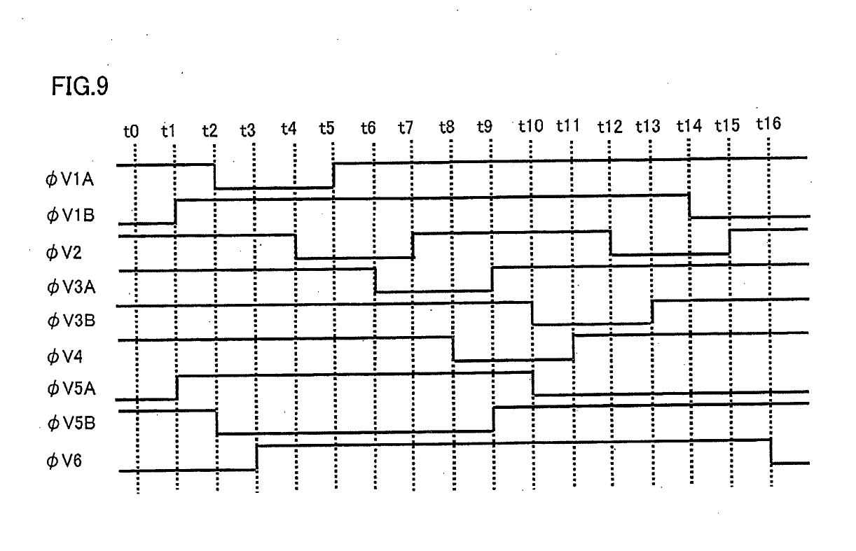

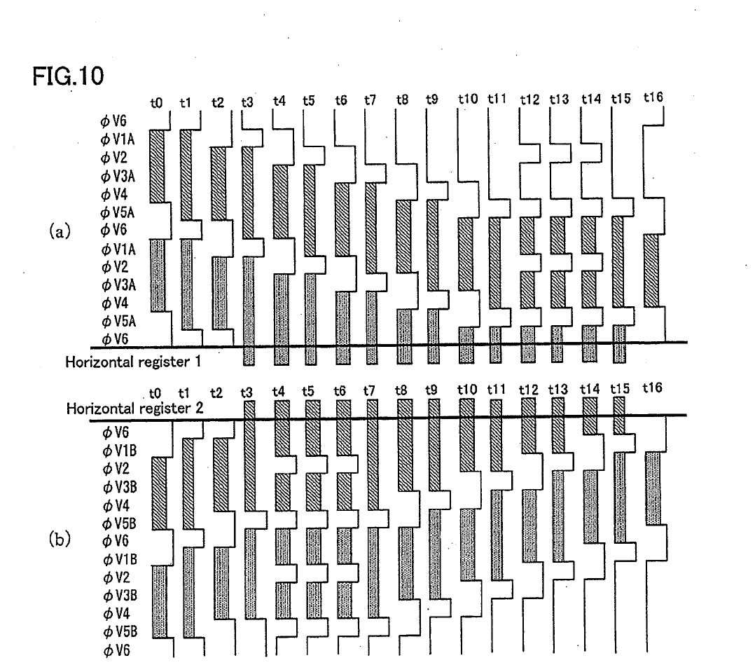

A case will be described with reference to FIG. 9 and FIG. 10 in which transfer control signals are applied with different timings to the second-layer gate electrodes 7a and 7b at the first vertical transfer registers 3a and the second vertical transfer registers 3b in order to control the transfer of signal electrical charges by six-phase drive from the first vertical transfer registers 3a and the second vertical transfer registers 3b to the horizontal transfer register 4a and the horizontal transfer register 4b in opposite directions in each group of columns.

FIG. 9 is a timing diagram showing drive timings when signal electrical charges are read out from vertical transfer registers to horizontal transfer registers in a six-phase drive method for the solid state image capturing device according to the embodiment of the present invention, that is, when signal electrical charges are read out to the horizontal transfer register 4a provided at the lower portion of an image capturing region in columns of the first vertical transfer registers 3a and signal electrical charges are read out to the horizontal transfer register 4b provided at the upper portion of the image capturing region in columns of the second vertical transfer registers 3b.

Portion (a) of FIG. 10 and Portion (b) of FIG. 10 each are a potential diagram showing a state of potentials in the first vertical transfer registers 3a and the second vertical transfer registers 3b when signal electrical charges are transferred in opposite directions in the six-phase drive method for the solid-state image capturing device in FIG. 9. Herein, a transfer cycle of one stage of the vertical transfer registers consists of times t1 to t16.

As shown in FIG. 9, first, at time t0, control signals φV2 and control signals φV4, and control signals φV6, which are applied to the first-layer gate electrodes 6 at the first vertical transfer registers 3a and the second vertical transfer registers 3b in an alternating manner, are at high level and at low level, respectively. In addition, control signals φV1A and control signals φV3A, and control signals φV5A, which are applied to the second-layer gate electrodes 7a at the first vertical transfer registers 3a in an alternating manner, are at high level and at low level, respectively. Further, control signals φV1B, and control signals φV3B and control signals φV5B, which are applied to the second-layer gate electrodes 7b at the second vertical transfer registers 3b in an alternating manner, are at low level and at high level, respectively.

Next, at time t1, control signals φV5A, which are applied to the second-layer gate electrodes 7a at the first vertical transfer registers 3a, are turned to high, and control signals φV1B, which are applied to the second-layer gate electrodes 7b at the second vertical transfer registers 3b, are turned to high.

At time t2, control signals φV1A, which are applied to the second-layer gate electrodes 7a at the first vertical transfer registers 3a, are turned to low, and control signals φV5B, which are applied to the second-layer gate electrodes 7b at the second vertical transfer registers 3b, are turned to low.

At time t3, control signals φV6, which are applied to the first-layer gate electrodes 6 at the first vertical transfer registers 3a and the second vertical transfer registers 3b, are turned to high.

At time t4, control signals φV2, which are applied to the first-layer gate electrodes 6 at the first vertical transfer registers 3a and the second vertical transfer registers 3b, are turned to low.

At time t5, control signals φV1A, which are applied to the second-layer gate electrodes 7a at the first vertical transfer registers 3a, are turned to high.

At time t6, control signals φ3V, which are applied to the second-layer gate electrodes 7a at the first vertical transfer registers 3a, are turned to low.

At time t7, control signals φV2, which are applied to the first-layer gate electrodes 6 at the first vertical transfer registers 3a and the second vertical transfer registers 3b, are turned to high.

At time t8, control signals φV4, which are applied to the first-layer gate electrodes 6 at the first vertical transfer registers 3a and the second vertical transfer registers 3b, are turned to low.

At time t9, control signals φV3A, which are applied to the second-layer gate electrodes 7a at the first vertical transfer registers 3a, are turned to high, and control signals φV5B, which are applied to the second-layer gate electrodes 7b at the second vertical transfer registers 3b, are turned to high.

At time t10, control signals φV5A, which are applied to the second-layer gate electrodes 7a at the first vertical transfer registers 3a, are turned to low, and control signals φV3B, which are applied to the second-layer gate electrodes 7b at the second vertical transfer registers 3b, are turned to low.

At time t11, control signals φV4, which are applied to the first-layer gate electrodes 6 at the first vertical transfer registers 3a and the second vertical transfer registers 3b, are turned to high.

At time t12, control signals φV2, which are applied to the first-layer gate electrodes 6 at the first vertical transfer registers 3a and the second vertical transfer registers 3b, are turned to low.

At time t13, control signals φV3B, which are applied to the second-layer gate electrodes 7b at the second vertical transfer registers 3b, are turned to high.

At time t14, control signals φV1B, which are applied to the second-layer gate electrodes 7b at the second vertical transfer registers 3b, are turned to low.

At time t15, control signals φV2, which are applied to the first-layer gate electrodes 6 at the first vertical transfer registers 3a and the second vertical transfer registers 3b, are turned to high.

At time t16, control signals φV6, which are applied to the first-layer gate electrodes 6 at the first vertical transfer registers 3a and the second vertical transfer registers 3b, are turned to low.

In this manner, control signals φV1A, control signals φV3A and control signals φV5A, and control signals φV1B, control signals φV3B and control signals φV5B are applied with different timings to the second-layer gate electrodes 7a at the first vertical transfer registers 3a and the second-layer gate electrodes 7b at the second vertical transfer registers 3b. As such, in the columns of the first vertical transfer registers 3a, potentials are shifted downward in the vertical direction, and thus signal electrical charges are transferred to the horizontal transfer register 4a provided at the lower portion of the image capturing region, as shown in Portion (a) of FIG. 10. In addition, in the columns of the second vertical transfer registers 3b, potentials are shifted upward in the vertical direction, and thus signal electrical charges are transferred to the horizontal transfer register 4b provided at the upper portion of the image capturing region, as shown in Portion (b) of FIG. 10. The transfers of the signal electrical charges to the horizontal transfer registers 4a and 4b start at time t1 and end at time t16 at the vertical transfer registers 3a and 3b, at the same time. Providing adjustment times, such as times t12 to t15 shown in Portion (a) of FIG. 10 and times t4 to t7 shown in Portion (b) of FIG. 10, allows the readout described above. In this manner, it is possible to control the direction for transferring as well as the time for transferring (transfer timing) signal electrical charges in each group of columns.

(Six-Phase Drive Method in the Same Vertical Transfer Direction)

Next, a six-phase drive method in the same vertical transfer direction will be described.

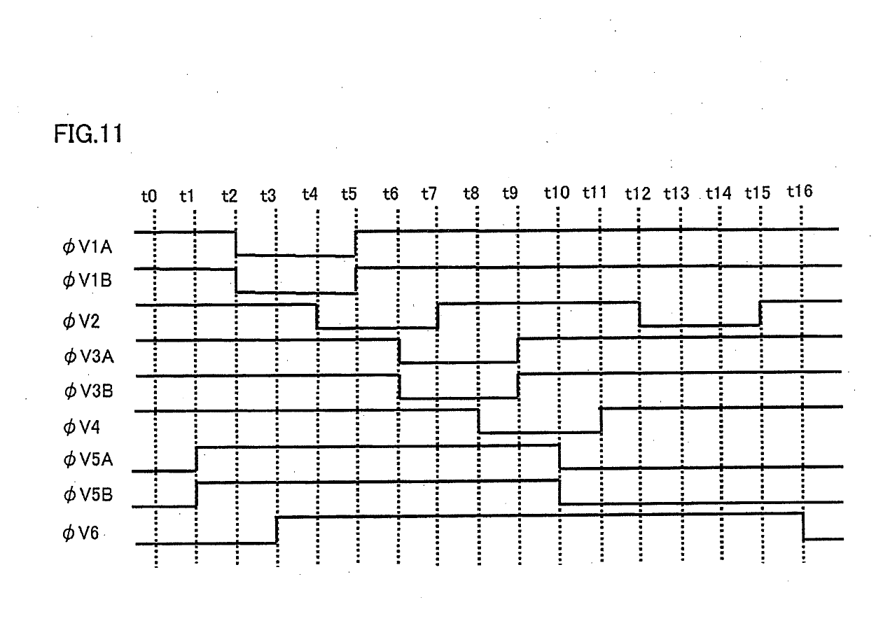

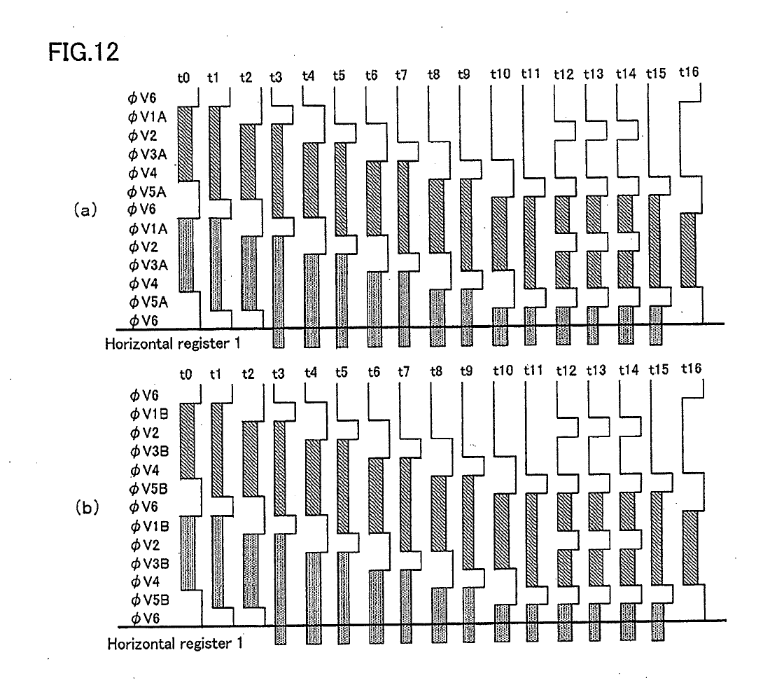

A case will be described with reference to FIG. 11 and FIG. 12 in which transfer control signals are applied with the same timings to the second-layer gate electrodes 7a and 7b at the first vertical transfer registers 3a and the second vertical transfer registers 3b in order to control the transfer of signal electrical charges by six-phase drive from the first vertical transfer registers 3a and the second vertical transfer registers 3b to the horizontal transfer register 4a (or 4b) in the same direction in each group of columns. A description herein will be made regarding the transfer of signal electrical charges to the horizontal transfer register 4a in FIG. 2 or the horizontal transfer register 4 in FIG. 1, each of which is provided at the lower portion of an image capturing region. Alternatively, signal electrical charges can be transferred to the horizontal transfer register 4b in FIG. 2, which is provided at the upper portion of the image capturing region.

FIG. 11 is a timing diagram showing drive timings when signal electrical charges are read out from vertical transfer registers to horizontal transfer registers in a six-phase drive method for the solid state image capturing device according to the embodiment of the present invention, that is, when signal electrical charges are read out to the horizontal transfer register 4a in FIG. 2 (or the horizontal transfer register 4 in FIG. 1) provided at the lower portion of an image capturing region in columns of both the first vertical transfer registers 3a and the second vertical transfer registers 3b.

Portion (a) of FIG. 12 and Portion (b) of FIG. 12 each are a potential diagram showing a state of potentials in the first vertical transfer registers 3a and the second vertical transfer registers 3b when signal electrical charges are transferred in the same direction in each column in the six-phase drive method for the solid-state image capturing device in FIG. 11. Herein, a transfer cycle of one stage of the vertical transfer registers consists of times t1 to t16.

As shown in FIG. 11, first, at time t0, control signals φV2 and control signals φV4, and control signals φV6, which are applied to the first-layer gate electrodes 6 at the first vertical transfer registers 3a and the second vertical transfer registers 3b in an alternating manner, are at high level and at low level, respectively. In addition, control signals φV1A and control signals φV3A, and control signals φV5A, which are applied to the second-layer gate electrodes 7a at the first vertical transfer registers 3a in an alternating manner, are at high level and at low level, respectively. Further, control signals φV1B and control signals φV3B, and control signals φV5B, which are applied to the second-layer gate electrodes 7b at the second vertical transfer registers 3b in an alternating manner, are at high level and at low level, respectively.

Next, at time t1, control signals φV5A, which are applied to the second-layer gate electrodes 7a at the first vertical transfer registers 3a, are turned to high, and control signals φV5B, which are applied to the second-layer gate electrodes 7b at the second vertical transfer registers 3b, are turned to high.

At time t2, control signals φV1A, which are applied to the second-layer gate electrodes 7a at the first vertical transfer registers 3a, are turned to low, and control signals φV1B, which are applied to the second-layer gate electrodes 7b at the second vertical transfer registers 3b, are turned to low.

At time t3, control signals φV6, which are applied to the first-layer gate electrodes 6 at the first vertical transfer registers 3a and the second vertical transfer registers 3b, are turned to high.

At time t4, control signals φV2, which are applied to the first-layer gate electrodes 6 at the first vertical transfer registers 3a and the second vertical transfer registers 3b, are turned to low.

At time t5, control signals φV1A, which are applied to the second-layer gate electrodes 7a at the first vertical transfer registers 3a, are turned high, and control signals φV1B, which are applied to the second-layer gate electrodes 7b at the second vertical transfer registers 3b, are turned to high.

At time t6, control signals φV3A, which are applied to the second-layer gate electrodes 7a at the first vertical transfer registers 3a, are turned to low, and control signals φV3B, which are applied to the second-layer gate electrodes 7b at the second vertical transfer registers 3b, are turned to low.

At time t7, control signals φV2, which are applied to the first-layer gate electrodes 6 at the first vertical transfer registers 3a and the second vertical transfer registers 3b, are turned to high.

At time t8, control signals φV4, which are applied to the first-layer gate electrodes 6 at the first vertical transfer registers 3a and the second vertical transfer registers 3b, are turned to low.

At time t9, control signals φV3A, which are applied to the second-layer gate electrodes 7a at the first vertical transfer registers 3a, are turned to high, and control signals φV3B, which are applied to the second-layer gate electrodes 7b at the second vertical transfer registers 3b, are turned to high.

At time t10, control signals φV5A, which are applied to the second-layer gate electrodes 7a at the first vertical transfer registers 3a, are turned to low, and control signals φV5B, which are applied to the second-layer gate electrodes 7b at the second vertical transfer registers 3b, are turned to low.

At time t11, control signals φV4, which are applied to the first-layer gate electrodes 6 at the first vertical transfer registers 3a and the second vertical transfer registers 3b, are turned to high.

At time t12, control signals φV2, which are applied to the first-layer gate electrodes 6 at the first vertical transfer registers 3a and the second vertical transfer registers 3b, are turned to low.

At times t13 and t14, the control signals do not change.

Further, at time t15, control signals φV2, which are applied to the first-layer gate electrodes 6 at the first vertical transfer registers 3a and the second vertical transfer registers 3b, are turned to high.

Last, at time t16, control signals φV6, which are applied to the first-layer gate electrodes 6 at the first vertical transfer registers 3a and the second vertical transfer registers 3b, are turned to low.

In this manner, control signals φV1A, control signals φV3A and control signals φV5A, and control signals φV1B, control signals φV3B and control signals φV5B are applied with the same timings to the second-layer gate electrodes 7a at the first vertical transfer registers 3a and the second-layer gate electrodes 7b at the second vertical transfer registers 3b. As such, in the columns of both the first vertical transfer registers 3a and the second vertical transfer registers 3b, potentials are shifted downward in the vertical direction, and thus signal electrical charges are transferred to the horizontal transfer register 4a provided at the lower portion of the image capturing region, as shown in Portion (a) of FIG. 12 and Portion (b) of FIG. 12. The transfers of the signal electrical charges to the horizontal transfer register 4a (or 4) start at time t1 and end at time t16 at the vertical transfer registers 3a and 3b, at the same time.

Further, at times t1 to t10 shown in FIG. 11, timings for applying control signals φV1A/φV3A/φV5A and control signals φV1B/φV3B/φV5B are changed, and thus a time difference is provided for reading out signal electrical charges from the first vertical transfer registers 3a and the second vertical transfer registers 3b to the horizontal transfer register 4a. As such, a readout can be performed in each group of columns. In this manner, it is possible to control the direction for transferring as well as the time for transferring (transfer timing) signal electrical charges in each group of columns.

(Eight-Phase Drive Method in Different Vertical Transfer Directions)

Next, an eight-phase drive method in different vertical transfer directions will be described.

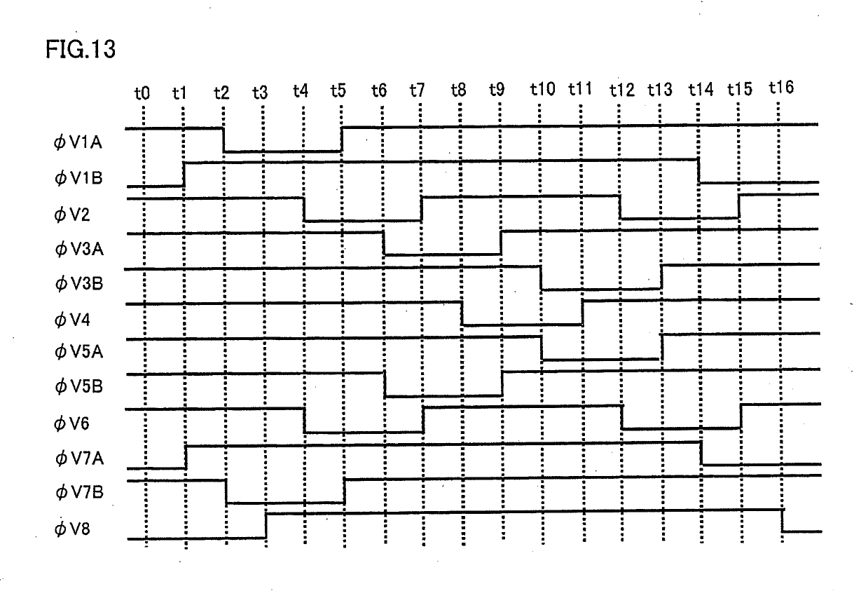

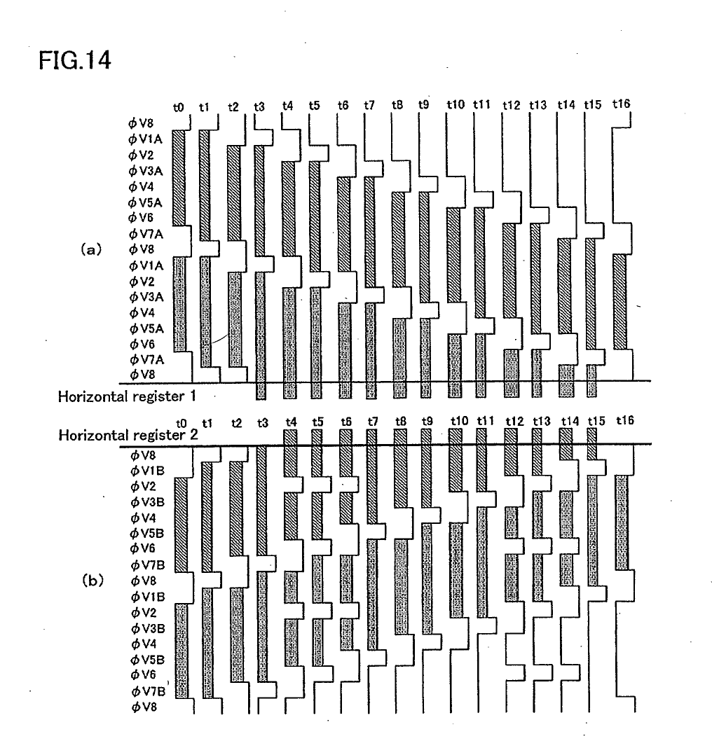

A case will be described with reference to FIG. 13 and FIG. 14 in which transfer control signals are applied with different timings to the second-layer gate electrodes 7a and 7b at the first vertical transfer registers 3a and the second vertical transfer registers 3b in order to control the transfer of signal electrical charges by eight-phase drive from the first vertical transfer registers 3a and the second vertical transfer registers 3b to the horizontal transfer register 4a and the horizontal transfer register 4b in opposite directions in each group of columns.

FIG. 13 is a timing diagram showing drive timings when signal electrical charges are read out from vertical transfer registers to horizontal transfer registers in an eight-phase drive method for the solid state image capturing device according to the embodiment of the present invention, that is, when signal electrical charges are read out to the horizontal transfer register 4a provided at the lower portion of an image capturing region in columns of the first vertical transfer registers 3a and signal electrical charges are read out to the horizontal transfer register 4b provided at the upper portion of the image capturing region in columns of the second vertical transfer registers 3b.

Portion (a) of FIG. 14 and Portion (b) of FIG. 14 each are a potential diagram showing a state of potentials in the first vertical transfer registers 3a and the second vertical transfer registers 3b when signal electrical charges are transferred in opposite directions in the eight-phase drive method for the solid-state image capturing device in FIG. 13. Herein, a transfer cycle of one stage of the vertical transfer registers consists of times t1 to t16.

As shown in FIG. 13, first, at time t0, control signals φV2, control signals φV4 and control signals φV6, and control signals φV8, which are applied to the first-layer gate electrodes 6 at the first vertical transfer registers 3a and the second vertical transfer registers 3b in an alternating manner, are at high level and at low level, respectively. In addition, control signals φV1A, control signals φV3A and control signals φV5A, and control signals φV7A, which are applied to the second-layer gate electrodes 7a at the first vertical transfer registers 3a in an alternating manner, are at high level and at low level, respectively. Further, control signals φV1B, and control signals φV3B, control signals φV5B and control signals φV7B, which are applied to the second-layer gate electrodes 7b at the second vertical transfer registers 3b in an alternating manner, are at low level and at high level, respectively.

Next, at time t1, control signals φV7A, which are applied to the second-layer gate electrodes 7a at the first vertical transfer registers 3a, are turned to high, and control signals φV1B, which are applied to the second-layer gate electrodes 7b at the second vertical transfer registers 3b, are turned to high.

At time t2, control signals φV1A, which are applied to the second-layer gate electrodes 7a at the first vertical transfer registers 3a, are turned to low, and control signals φV7B, which are applied to the second-layer gate electrodes 7b at the second vertical transfer registers 3b, are turned to low.

At time t3, control signals φV8, which are applied to the first-layer gate electrodes 6 at the first vertical transfer registers 3a and the second vertical transfer registers 3b, are turned to high.

At time t4, control signals φV2 and control signals V6, which are applied to the first-layer gate electrodes 6 at the first vertical transfer registers 3a and the second vertical transfer registers 3b, are turned to low.

At time t5, control signals φV1A, which are applied to the second-layer gate electrodes 7a at the first vertical transfer registers 3a, are turned to high, and control signals φV7B, which are applied to the second-layer gate electrodes 7b at the second vertical transfer registers 3b, are turned to high.

At time t6, control signals φV3A, which are applied to the second-layer gate electrodes 7a at the first vertical transfer registers 3a, are turned to low, and control signals φV5B, which are applied to the second-layer gate electrodes 7b at the second vertical transfer registers 3b, are turned to low.

At time t7, control signals φV2 and control signals φV6, which are applied to the first-layer gate electrodes 6 at the first vertical transfer registers 3a and the second vertical transfer registers 3b, are turned to high.

At time t8, control signals φV4, which are applied to the first-layer gate electrodes 6 at the first vertical transfer registers 3a and the second vertical transfer registers 3b, are turned to low.

At time t9, control signals φV3A, which are applied to the second-layer gate electrodes 7a at the first vertical transfer registers 3a, are turned to high, and control signals φV5B, which are applied to the second-layer gate electrodes 7b at the second vertical transfer registers 3b, are turned to high.

At time t10, control signals φV5A, which are applied to the second-layer gate electrodes 7a at the first vertical transfer registers 3a, are turned to low, and control signals φV3B, which are applied to the second-layer gate electrodes 7b at the second vertical transfer registers 3b, are turned to low.

At time t11, control signals φV4, which are applied to the first-layer gate electrodes 6 at the first vertical transfer registers 3a and the second vertical transfer registers 3b, are turned to high.

At time t12, control signals φV2 and control signals φV6, which are applied to the first-layer gate electrodes 6 at the first vertical transfer registers 3a and the second vertical transfer registers 3b, are turned to low.

At time t13, control signals φV5A, which are applied to the second-layer gate electrodes 7a at the first vertical transfer registers 3a, are turned to high, and control signals φV3B, which are applied to the second-layer gate electrodes 7b at the second vertical transfer registers 3b, are turned to high.

At time t14, control signals φV7A, which are applied to the second-layer gate electrodes 7a at the first vertical transfer registers 3a, are turned to low, and control signals φV1B, which are applied to the second-layer gate electrodes 7b at the second vertical transfer registers 3b, are turned to low.

Further, at time t15, control signals φV2 and control signals φV6, which are applied to the first-layer gate electrodes 6 at the first vertical transfer registers 3a and the second vertical transfer registers 3b, are turned to high.

Last, at time t16, control signals φV8, which are applied to the first-layer gate electrodes 6 at the first vertical transfer registers 3a and the second vertical transfer registers 3b, are turned to low.

In this manner, control signals φV1A, control signals φV3A, control signals φV5A and control signals V7A, and control signals φV1B, control signals φV3B, control signals φV5B and control signals φV7B are applied with different timings to the second-layer gate electrodes 7a at the first vertical transfer registers 3a and the second-layer gate electrodes 7b at the second vertical transfer registers 3b. As such, in the columns of the first vertical transfer registers 3a, potentials are shifted downward in the vertical direction, and thus signal electrical charges are transferred to the horizontal transfer register 4a provided at the lower portion of the image capturing region, as shown in Portion (a) of FIG. 14. In addition, in the columns of the second vertical transfer registers 3b, potentials are shifted upward in the vertical direction, and thus signal electrical charges are transferred to the horizontal transfer register 4b provided at the upper portion of the image capturing region, as shown in Portion (b) of FIG. 14. The transfers of the signal electrical charges to the horizontal transfer registers 4a and 4b start at time t1 and end at time t16 at the vertical transfer registers 3a and 3b, at the same time.

(Eight-Phase Drive Method in the Same Vertical Transfer Direction)

Next, an eight-phase drive method in the same vertical transfer direction will be described.

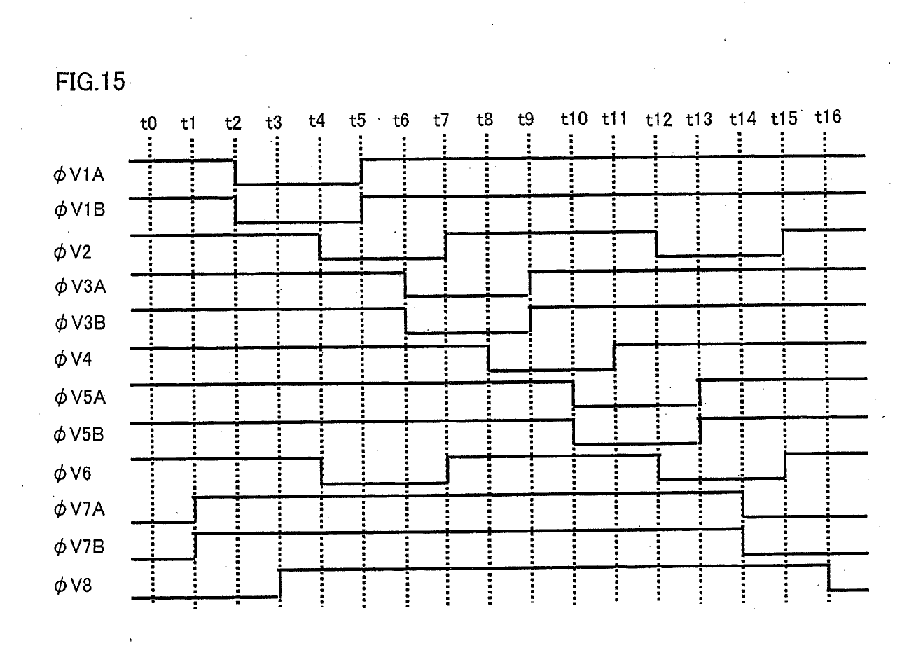

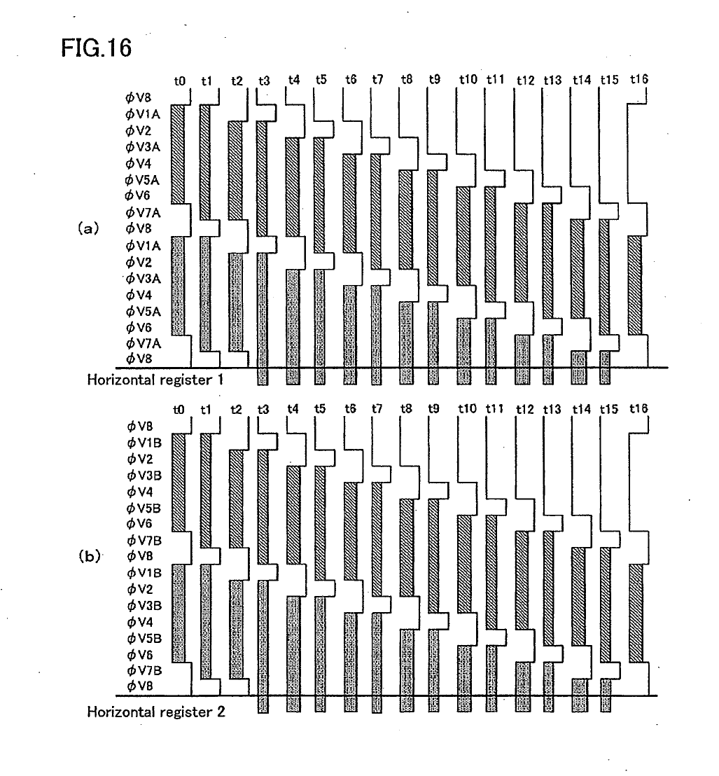

A case will be described with reference to FIG. 15 and FIG. 16 in which transfer control signals are applied with the same timings to the second-layer gate electrodes 7a and 7b at the first vertical transfer registers 3a and the second vertical transfer registers 3b in order to control the transfer of signal electrical charges by eight-phase drive from the first vertical transfer registers 3a and the second vertical transfer registers 3b to the horizontal transfer register 4a (or 4b) in the same direction in each group of columns. A description herein will be made regarding the transfer of signal electrical charges to the horizontal transfer register 4a in FIG. 2 or the horizontal transfer register 4 in FIG. 1, each of which is provided at the lower portion of an image capturing region. Alternatively, signal electrical charges can be transferred to the horizontal transfer register 4b in FIG. 2, which is provided at the upper portion of the image capturing region.

FIG. 15 is a timing diagram showing drive timings when signal electrical charges are read out from vertical transfer registers to horizontal transfer registers in an eight-phase drive method for the solid state image capturing device according to the embodiment of the present invention, that is, when signal electrical charges are read out to the horizontal transfer register 4a in FIG. 2 (or the horizontal transfer register 4 in FIG. 1) provided at the lower portion of an image capturing region in columns of both the first vertical transfer registers 3a and the second vertical transfer registers 3b.

Portion (a) of FIG. 16 and Portion (b) of FIG. 16 each are a potential diagram showing a state of potentials in the first vertical transfer registers 3a and the second vertical transfer registers 3b when signal electrical charges are transferred in the same direction in each column in the eight-phase drive method for the solid-state image capturing device in FIG. 15. Herein, a transfer cycle of one stage of the vertical transfer registers consists of times t1 to t16.

As shown in FIG. 15, first, at time t0, control signals φV2, control signals φV4 and control signals φV6, and control signals φV8, which are applied to the first-layer gate electrodes 6 at the first vertical transfer registers 3a and the second vertical transfer registers 3b in an alternating manner, are at high level and at low level, respectively. In addition, control signals φV1A, control signals φV3A and control signals φV5A, and control signals φV7A, which are applied to the second-layer gate electrodes 7a at the first vertical transfer registers 3a in an alternating manner, are at high level and at low level, respectively. Further, control signals φV1B, control signals φV3B and control signals φV5B, and control signals φV7B, which are applied to the second-layer gate electrodes 7b at the second vertical transfer registers 3b in an alternating manner, are at high level and at low level, respectively.

Next, at time t1, control signals φV7A, which are applied to the second-layer gate electrodes 7a at the first vertical transfer registers 3a, are turned to high, and control signals φV7B, which are applied to the second-layer gate electrodes 7b at the second vertical transfer registers 3b, are turned to high.

At time t2, control signals φV1A, which are applied to the second-layer gate electrodes 7a at the first vertical transfer registers 3a, are turned to low, and control signals φV1B, which are applied to the second-layer gate electrodes 7b at the second vertical transfer registers 3b, are turned to low.

At time t3, control signals φV8, which are applied to the first-layer gate electrodes 6 at the first vertical transfer registers 3a and the second vertical transfer registers 3b, are turned to high.

At time t4, control signals φV2 and control signals φV6, which are applied to the first-layer gate electrodes 6 at the first vertical transfer registers 3a and the second vertical transfer registers 3b, are turned to low.

At time t5, control signals φV1A, which are applied to the second-layer gate electrodes 7a at the first vertical transfer registers 3a, are turned high, and control signals V1B, which are applied to the second-layer gate electrodes 7b at the second vertical transfer registers 3b, are turned to high.

At time t6, control signals φV3A, which are applied to the second-layer gate electrodes 7a at the first vertical transfer registers 3a, are turned to low, and control signals φV3B, which are applied to the second-layer gate electrodes 7b at the second vertical transfer registers 3b, are turned to low.

At time t7, control signals φV2 and control signals φV6, which are applied to the first-layer gate electrodes 6 at the first vertical transfer registers 3a and the second vertical transfer registers 3b, are turned to high.

At time t8, control signals φV4, which are applied to the first-layer gate electrodes 6 at the first vertical transfer registers 3a and the second vertical transfer registers 3b, are turned to low.

At time t9, control signals φV3A, which are applied to the second-layer gate electrodes 7a at the first vertical transfer registers 3a, are turned to high, and control signals φV3B, which are applied to the second-layer gate electrodes 7b at the second vertical transfer registers 3b, are turned to high.

At time t10, control signals φV5A, which are applied to the second-layer gate electrodes 7a at the first vertical transfer registers 3a, are turned to low, and control signals φV5B, which are applied to the second-layer gate electrodes 7b at the second vertical transfer registers 3b, are turned to low.

At time t11, control signals φV4, which are applied to the first-layer gate electrodes 6 at the first vertical transfer registers 3a and the second vertical transfer registers 3b, are turned to high.

At time t12, control signals φV2 and control signals φV6, which are applied to the first-layer gate electrodes 6 at the first vertical transfer registers 3a and the second vertical transfer registers 3b, are turned to low.

At time t13, control signals φV5A, which are applied to the second-layer gate electrodes 7a at the first vertical transfer registers 3a, are turned to high, and control signals φV5B, which are applied to the second-layer gate electrodes 7b at the second vertical transfer registers 3b, are turned to high.

At time t14, control signals φV7A, which are applied to the second-layer gate electrodes 7a at the first vertical transfer registers 3a, are turned to low, and control signals φV7B, which are applied to the second-layer gate electrodes 7b at the second vertical transfer registers 3b, are turned to low.

Further, at time t15, control signals φV2 and control signals φV6, which are applied to the first-layer gate electrodes 6 at the first vertical transfer registers 3a and the second vertical transfer registers 3b, are turned to high.

Last, at time t16, control signals φV8, which are applied to the first-layer gate electrodes 6 at the first vertical transfer registers 3a and the second vertical transfer registers 3b, are turned to low.

In this manner, control signals φV1A, control signals φV3A, control signals φV5A and control signals V7A, and control signals φV1B, control signals φV3B, control signals φV5B and control signals φV7B are applied with the same timings to the second-layer gate electrodes 7a at the first vertical transfer registers 3a and the second-layer gate electrodes 7b at the second vertical transfer registers 3b. As such, in the columns of both the first vertical transfer registers 3a and the second vertical transfer registers 3b, potentials are shifted downward in the vertical direction, and thus signal electrical charges are transferred to the horizontal transfer register 4a provided at the lower portion of the image capturing region, as shown in Portion (a) of FIG. 16 and Portion (b) of FIG. 16. The transfers of the signal electrical charges to the horizontal transfer register 4a (or 4) start at time t1 and end at time t16 at the vertical transfer registers 3a and 3b, at the same time.

Further, at times t1 to t15 shown in FIG. 15, timings for applying control signals φV1A/φV3A/φV5A/φV7A and control signals φV1B/φV3B/φV5B/φV7B are changed, and thus a time difference is provided for reading out signal electrical charges from the first vertical transfer registers 3a and the second vertical transfer registers 3b to the horizontal transfer register 4a. As such, a readout can be performed in each group of columns.

Next, an embodiment of a method for driving the solid-state image capturing device according to the present invention will be described, in which the readout of signal electrical charges from light receiving sections to vertical transfer registers is controlled in each group of columns.

(Drive for Fast Readout by Data Decimation)

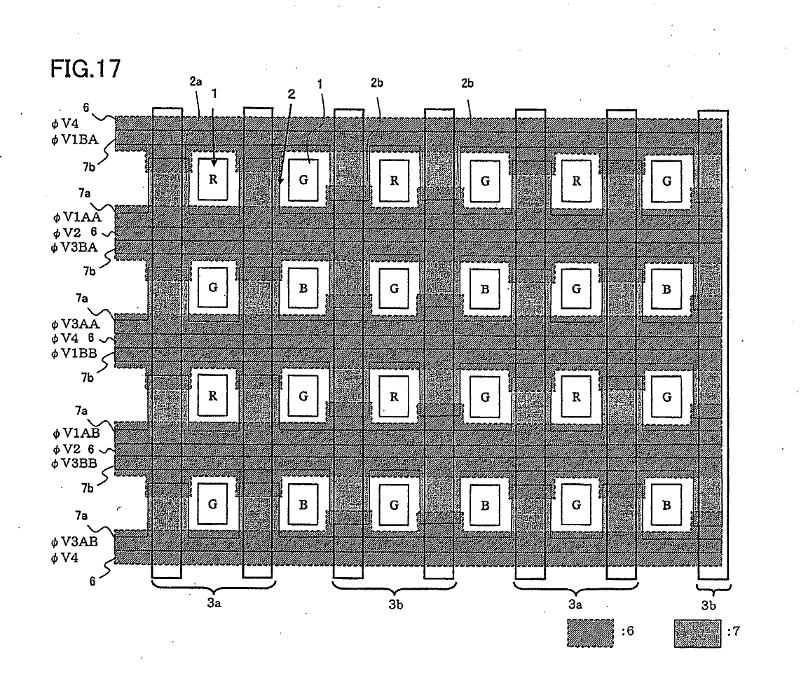

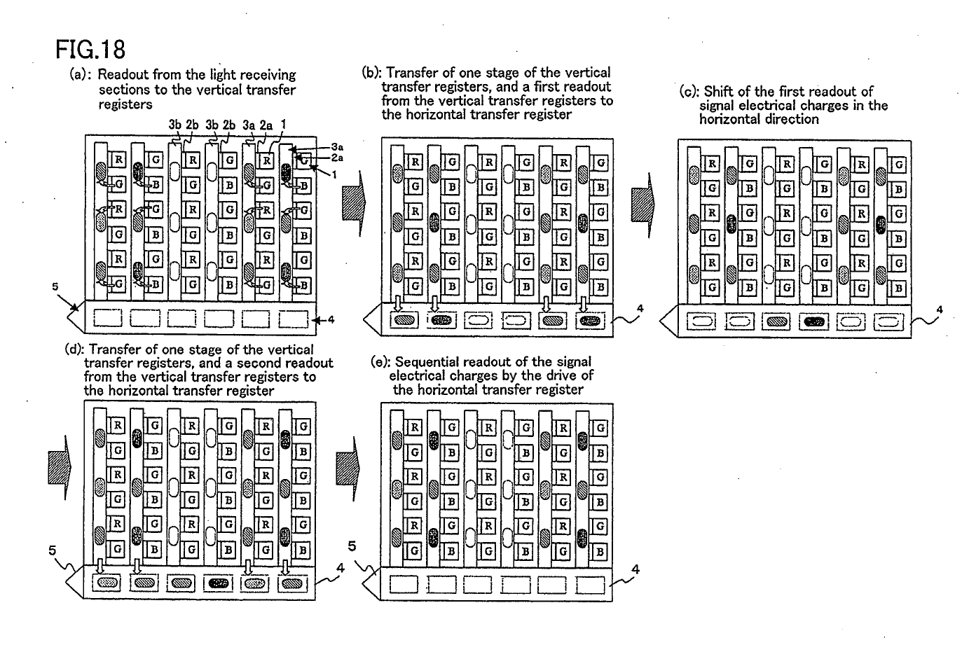

First, a method for a fast readout of signal electrical charges by decimating data in a horizontal direction will be described with reference to FIG. 17 and FIG. 18.

FIG. 17 is a plane view of the gate electrode structure of the vertical transfer registers of the solid-state image capturing device in FIG. 1 or FIG. 2.

In FIG. 17, the first vertical transfer registers 3a and the second vertical transfer registers 3b are repeatedly arranged in every two columns in an alternating manner.

The patterns of the first-layer gate electrodes 6 at the first vertical transfer registers 3a and the second vertical transfer registers 3b are the same. For example, when the first vertical transfer registers 3a and the second vertical transfer registers 3b are driven by four-phase drive, control signals φV2 and control signals φV4 are applied to the first-layer gate electrodes 6 at the first vertical transfer registers 3a and the second vertical transfer registers 3b in each column in an alternating manner, as shown in FIG. 17.

In addition, the patterns of the second-layer gate electrodes 7a and 7b at the first vertical transfer registers 3a and the second vertical transfer registers 3b are two types, different from each other. For example, when the first vertical transfer registers 3a and the second vertical transfer registers 3b are driven by four-phase drive, control signals φV1AA, control signals φV3AA, control signals φV1AB and control signals φV3AB are applied to the second-layer gate electrodes 7a at the first vertical transfer registers 3a in each column in an alternating manner, as shown in FIG. 17. In addition, control signals φV1BA, control signals φV3BA, control signals φV1BB and control signals φV3BB are applied to the second-layer gate electrodes 7b at the second vertical transfer registers 3b in each column in an alternating manner. Readout control signals for the transfer gates 2a and 2b are applied to the second-layer gate electrodes 7a and 7b.

Portion (a) of FIG. 18 to Portion (e) of FIG. 18 each are a diagram for describing a method for controlling the readout of signal electrical charges from the light receiving sections to the vertical transfer registers in each group of columns, and reading out the signal electrical charges at high speed by decimating data in the solid-state image capturing device in FIG. 17.

First, as shown in Portion (a) of FIG. 18, signal electrical charges are read out from the light receiving sections 1 to the first vertical transfer registers 3a. In other words, readout control signals are applied only to the second-layer gate electrodes 7a applied with control signals φV1AA and φV3AB in FIG. 17 or only to the second-layer gate electrodes 7a applied with control signals φV1AB and φV3AA in FIG. 17. As such, signal electrical charges are read out from the light receiving sections 1 to the first vertical transfer registers 3a via the first transfer gates 2a. In this case, data is decimated in the vertical direction as well as the horizontal direction (data to the first vertical transfer registers 3b in every two columns is decimated).

Next, the signal electrical charges are transferred by one frame (equivalent to one light receiving section) in the vertical direction by the first vertical transfer registers 3a and the second vertical transfer registers 3b, and thus a first readout of the signal electrical charges is performed from the first vertical transfer registers 3a and the second vertical transfer registers 3b to the horizontal transfer register 4. In this case, the second vertical transfer registers 3b transfer signal electrical charges in an “empty” state. As shown in Portion of (b) of FIG. 18, no signal electrical charge is read out from the light receiving sections 1 to the second vertical transfer registers 3b. Therefore, only the signal electrical charges, which have been read out from the lowest light receiving sections “G” and “B” in two columns of the first vertical transfer registers 3a, are read out to the horizontal transfer register 4.

Thereafter, as shown in Portion (c) of FIG. 18, the signal electrical charges which have been read out from the light receiving sections “G” and “B” in the two columns in the first readout of the signal electrical charges are transferred by the horizontal transfer register 4 by two frames to the left in the horizontal direction.

Further, the signal electrical charges are transferred by one frame in the vertical direction by the first vertical transfer registers 3a and the second vertical transfer registers 3b, and thus a second readout of the signal electrical charges is performed from the first vertical transfer registers 3a and the second vertical transfer registers 3b to the horizontal transfer register 4. As shown in Portion of (d) of FIG. 18, no signal electrical charge is read out from the light receiving sections 1 to the second vertical transfer registers 3b. Therefore, only the signal electrical charges, which have been read out from the light receiving sections “R” and “G” in two columns of the first vertical transfer registers 3a, are read out to the horizontal transfer register 4.

Further, as shown in Portion (e) of FIG. 18, the signal electrical charges are transferred in the horizontal direction by the horizontal transfer register 4, and image-capturing signals are sequentially output from the output amplifier 5 as a signal output section.

As described above, the readout control signals are applied only to the first transfer gates 2a for reading out the signal electrical charges from the light receiving sections 1 to the first vertical transfer registers 3a, and no readout control signal is applied to the second transfer gates 2b for reading out the signal electrical charges from the light receiving sections 1 to the second vertical transfer registers 3b. As such, the data in the horizontal direction is decimated, and the fast readout is implemented.

(Drive for Reading Out Signal Electrical Charges Having Different Accumulation Times at Light Portions and Dark Portions)

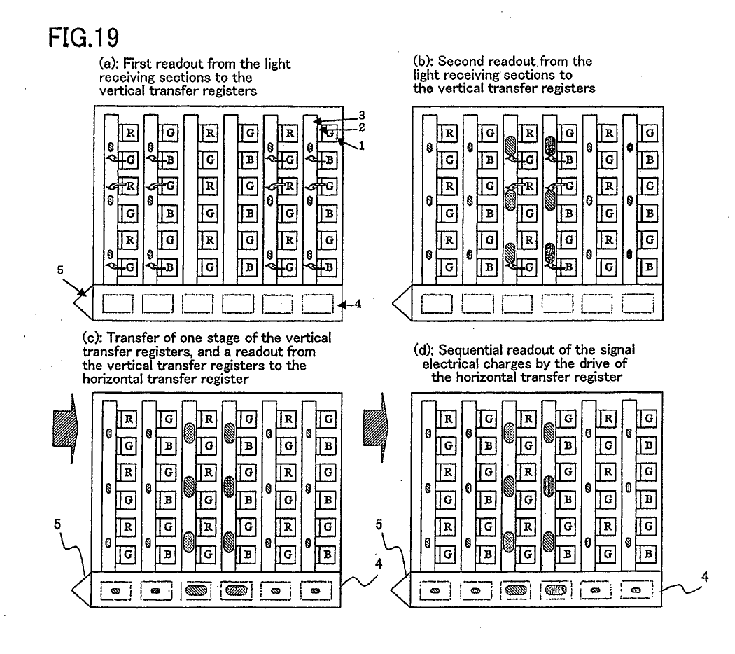

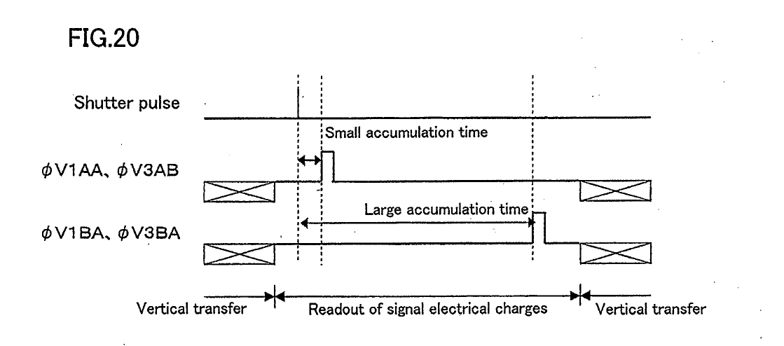

Next, a method for reading out signal electrical charges will be described with reference to FIG. 17, FIG. 19 and FIG. 20, in which exposures are performed on the light receiving sections in accordance with light portions and dark portions thereon, and accumulation times (functions of the light receiving sections) are different.

FIG. 19 is a diagram for describing a method for reading out signal electrical charges in the method for driving the solid-state image capturing device in FIG. 17, in which the readout of signal electrical charges from light receiving sections to vertical transfer registers is controlled in each group of columns, and accumulation times are different in accordance with the light portions and the dark portions. FIG. 20 is a timing diagram for describing drive timings for implementing a method for driving the light receiving sections at the light potions and the dark portions in the solid-state image capturing device in FIG. 17.

First, as shown in Portion (a) of FIG. 19, readout control signals are applied only to the second-layer gate electrodes 7a applied with control signals φV1AA and +V3AB in FIG. 17. As such, signal electrical charges are read out from the light receiving sections 1 to the first vertical transfer registers 3a via the first transfer gates 2a. Herein, as shown in FIG. 20, after a shutter pulse is applied, the readout control signals are applied after the passing of about 1/10th of the time for normal accumulation period (e.g., in case of NTCS, 1/60 seconds).

Next, as shown in Portion (b) of FIG. 19, readout control signals are applied only to the second-layer gate electrodes 7b applied with control signals φV1BA and +V3BB in FIG. 17. As such, signal electrical charges are read out from the light receiving sections 1 to the second vertical transfer registers 3b via the second transfer gates 2b. Herein, as shown in FIG. 20, after a shutter pulse is applied, the readout control signals are applied after the passing of the normal accumulation period.

Further, as shown in Portion (c) of FIG. 19, the signal electrical charges are transferred by one frame in the vertical direction by the first vertical transfer registers 3a and the second vertical transfer registers 3b, and thus a readout of the signal electrical charges is performed from the first vertical transfer registers 3a and the second vertical transfer registers 3b to the horizontal transfer register 4.

Next, as shown in Portion (d) of FIG. 19, the signal electrical charges are transferred in the horizontal direction by the horizontal transfer register 4, and image-capturing signals are sequentially output from the output amplifier 5 as a signal output section.

In this manner, the readout control signals are applied to the first transfer gates 2a and the second transfer gates 2b with different timings. As such, it is possible to simultaneously read out long-time accumulated signals in accordance with the light portions and short-time accumulated signals in accordance with the dark portions in one field period. Two pieces of data output from the light portions and the dark portions are combined, so that data having a wide dynamic range can be created.

As described above, according to the present embodiment, transfer electrodes having a simple structure of a two-layered electrode structure are used, and the patterns of the first gate electrodes 6 at the first vertical transfer registers 3a and the second vertical transfer registers 3b are the same so as to apply control signals to the first-layer gate electrodes 6 with the same time timings, and the patterns of the second gate electrodes 7a and 7b at the first vertical transfer registers 3a and the second vertical transfer registers 3b are different from each other so as to apply control signals to the second gate electrodes 7a and 7b with timings independent of each other. Further, the transfer gates 2a and 2b connected with the second-layer gate electrodes 7a and 7b, respectively, are provided such that signal electrical charges are read out from the light receiving sections 1 to the vertical transfer registers 3a and 3b with timings independent of each other. By applying control signals independent of each other to the second-layer gate electrodes 7a and 7b, respectively, it is possible, in each group of columns, to control the time for reading out from the light receiving sections 1 to the vertical transfer registers 3a and 3b, the time for reading out from the vertical transfer registers 3a and 3b to the horizontal transfer register 4 and the direction for transferring and the time for transferring (transfer timing) signal electrical charges from the vertical transfer registers 3a and 3b.

The present embodiment has made no specific description. However, it should be noted that if the first-layer electrodes 6 and the second-layer electrodes 7 are arranged in an alternating manner so as to drive the vertical transfer registers 3 by n-phase drive, and if the vertical transfer registers 3 include the first vertical transfer registers 3a for transferring signal electrical charges read out from the light receiving sections 1 in one direction or an other direction, and the second vertical transfer registers 3b for transferring signal electrical charges, in the one direction or the other direction, with timings independent of those for the first vertical transfer registers 3a, it is possible to achieve the objective of the present invention with two-layered gate electrodes having a simple structure of controlling, in each column, the readout of signal electrical charges from the light receiving sections 1 to the vertical transfer registers 3, the readout of the signal electrical charges from the vertical transfer registers 3 to the horizontal transfer register 4, and the direction for transferring and the time for transferring the signal electrical charges from the vertical transfer registers 3.

In addition, the embodiment has described the cases in which the first vertical transfer registers 3a and the second vertical transfer registers 3b are arranged in an alternating manner in each column or every two columns. However, the present invention is not limited. Alternatively, the first vertical transfer registers 3a and the second vertical transfer registers 3b can be arranged in an alternating manner in every m columns (m is an integer greater than or equal to 1) (e.g., in every three columns, in every four columns or the like).

Further, the embodiment has described the cases of four-phase drive, six-phase drive and eight-phase drive. However, the present invention is not limited to this. Alternatively, ten-phase drive or n-phase drive can be used.

Further, the embodiment described above has made no specific description. A specific method for providing a time difference will be described.

First, an example of method for providing a time difference in a four-phase drive method in the same vertical transfer direction will be described.

Assume that one cycle consists of times t0 to t8 in the timing diagram in FIG. 7. First, at times t0 to t3 during the first cycle, control signals φV3B are turned to low, so that the transfer from the vertical transfer registers 3b to the horizontal transfer register 4a stops. In this case, control signals φV1B are turned to high in order to store signal electrical charges from the vertical transfer registers 3b. Next, at times t0 to t3 during the second cycle, control signals φV3A are turned to low, so that the transfer from the vertical transfer registers 3a to the horizontal transfer register 4a stops. In this case, control signals φV1A are turned to high in order to store signal electrical charges from the vertical transfer registers 3a. As such, it is possible to read out the signal electrical charges only from the vertical transfer registers 3a to the horizontal transfer register 4a during the first cycle and also possible to read out the signal electrical charges only from the vertical transfer registers 3b to the horizontal transfer register 4a during the second cycle. Therefore, it is possible to implement the readout of signal electrical charges with a time difference provided between the first vertical transfer registers 3a and the second vertical transfer registers 3b.

Next, an example of method for providing a time difference in a six-phase drive method in the same vertical transfer direction will be described.

Assume that one cycle consists of times t0 to t16 in the timing diagram in FIG. 11. First, at times t3 to t9 during the first cycle, control signals φV5B are turned to low, so that the transfer from the vertical transfer registers 3b to the horizontal transfer register 4a stops. In this case, control signals φV1B and control signals φV3B are turned to high in order to store signal electrical charges from the vertical transfer registers 3b. Next, at times t3 to t9 during the second cycle, control signals φV5A are turned to low, so that the transfer from the vertical transfer registers 3a to the horizontal transfer register 4a stops. In this case, control signals φV1A and control signals φV3A are turned to high in order to store signal electrical charges from the vertical transfer registers 3a. As such, it is possible to read out the signal electrical charges only from the vertical transfer registers 3a to the horizontal transfer register 4a during the first cycle and also possible to read out the signal electrical charges only from the vertical transfer registers 3b to the horizontal transfer register 4a during the second cycle. Therefore, it is possible to implement the readout of signal electrical charges with a time difference provided between the first vertical transfer registers 3a and the second vertical transfer registers 3b.

Next, an example of method for providing a time difference in an eight-phase drive method in the same vertical transfer direction will be described.

Assume that one cycle consists of times t0 to t16 in the timing diagram in FIG. 15. First, at times t3 to t13 during the first cycle, control signals φV7B are turned to low, so that the transfer from the vertical transfer registers 3b to the horizontal transfer register 4a stops. In this case, control signals φV1B/φV3B/φV5B are turned to high in order to store signal electrical charges from the vertical transfer registers 3b. Next, at times t3 to t13 during the second cycle, control signals φV7A are turned to low, so that the transfer from the vertical transfer registers 3a to the horizontal transfer register 4a stops. In this case, control signals φV1A/φV3A/φV5A are turned to high in order to store signal electrical charges from the vertical transfer registers 3a. As such, it is possible to read out the signal electrical charges only from the vertical transfer registers 3a to the horizontal transfer register 4a during the first cycle and also possible to read out the signal electrical charges only from the vertical transfer registers 3b to the horizontal transfer register 4a during the second cycle. Therefore, it is possible to implement the readout of signal electrical charges with a time difference provided between the first vertical transfer registers 3a and the second vertical transfer registers 3b.

Further, in the embodiment, the readout can be performed by providing adjustment times, such as times t12 to t15 in Portion (a) of FIG. 10 and times t4 to t7 in Portion (b) of FIG. 10, as described above. However, such adjustment times have not been particularly described above. Thus, they will be described herein.

For example, in case of 4n-phase drive (n=1, 2, 3 . . . ), by making control signals of group A in the odd number columns and control signals of group B in the even number columns symmetrical to each other with respect to the drive timing in the same vertical transfer direction, it is possible to drive in the upward and downward vertical transfer directions.

In case of four-phase drive, by making “V1B=φV3A, φV3B=φV1A”, and in case of eight-phase drive, by making “φV1B=φV7A, φV3B=φV5A, V5B=φV3A, φV7B=φV1A”, it is possible to drive in upward and downward different vertical transfer directions.

However, in case of 4n+two-phase drive (n=1, 2, 3 . . . ), signal electrical charges which have been read out are mixed with each other if the control signals in the odd-number columns and the control signals in the even-number columns are simply symmetrical to each other with respect to the drive timing in the same vertical transfer direction. Therefore, it is necessary to provide adjustment times for the transfer such that the signal electrical charges which have been read out are not mixed with each other.

When a transfer is performed with six-phase drive, times t4 to t7 in FIG. 10 are unnecessary, only in view of the transfer in Portion (b) of FIG. 10. However, by fixing control signals φV2 at low level during times t4 to t7, signal electrical charges can be transferred without mixing each other in Portion (a) of FIG. 10.

In addition, times t12 to t15 in FIG. 10 are unnecessary, only in view of the transfer in Portion (a) of FIG. 10. However, by fixing control signals φV2 at low level during times t12 to t15, signal electrical charges can be transferred without mixing each other in Portion (b) of FIG. 10.

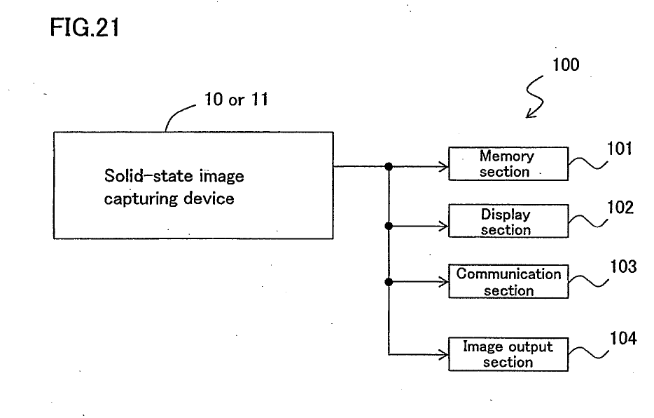

Further, the embodiment described above has made no specific description. In FIG. 21, a description will be given regarding an electronic information device 100 having, for example, a digital camera (e.g., digital video camera, digital still camera), an image input camera (e.g., monitoring camera, door intercom camera, car-mounted camera, camera for television telephone and camera for cell phone), and an image input device (e.g., scanner, facsimile and cell phone device equipped with camera) using the solid-state image capturing device 10 or 11 according to the embodiment of the present invention for an image capturing section thereof. The electronic information device 100 according to the present invention includes: a memory section 101 (e.g., recording media) for data-recording image data, which is obtained by performing a predetermined signal process on a high-quality image capturing signal obtained by using the solid-state image capturing device 10 or 11 according to the embodiment of the present invention for the image capturing section after a predetermined signal process is performed on the image data for recording; display section 102 (e.g., liquid crystal display device) for displaying this image data on a display screen (e.g., liquid crystal display screen) after a predetermined signal process is performed on the image data for display; communication section 103 (e.g., transmitting and receiving device) for communicating this image data after a predetermined signal process is performed on the image data for communication; and image output section 104 for printing (typing out) and outputting (printing out) this image data. It should be noted that the electronic information device 100 according to the present invention only has to include: one of the memory section 101, the display section 102, the communication section 103 and the image output section 104.

As described above, the present invention is exemplified by the use of its preferred embodiment(s). However, the present invention should not be interpreted solely based on the embodiment(s) described above. It is understood that the scope of the present invention should be interpreted solely based on the claims. It is also understood that those skilled in the art can implement equivalent scope of technology, based on the description of the present invention and common knowledge from the description of the detailed preferred embodiments of the present invention. Furthermore, it is understood that any patent, any patent application and any references cited in the present specification should be incorporated by reference in the present specification in the same manner as the contents are specifically described therein.

### INDUSTRIAL APPLICABILITY

According to the present invention, in a field of: a solid-state image capturing device having a plurality of semiconductor devices as pixel sections for performing a photoelectrical conversion on image light from a subject and capturing an image of the subject; a method for driving the solid-state image capturing device; and an electronic information device (e.g., digital camera (digital video camera, digital still camera and the like), image input camera, scanner, facsimile, cell phone device equipped with camera and the like) using the solid-state image capturing device as an image input device for an image capturing section thereof, with the first vertical transfer sections and the second vertical transfer sections which can apply control signals only to the second-layer gate electrodes with different timings using two-layered gate electrodes having a simple structure, it is possible to control a drive timing in each group of columns. As such, it is possible to control the time for reading signal electrical charges from the vertical transfer sections to the horizontal transfer section in each group of columns and the direction for transferring the signal electrical charges from the vertical transfer sections. In addition, with the first signal readout sections and the second signal readout sections connected to the second-layer gate electrodes such that readouts from each of the light receiving sections to each of the vertical transfer sections are performed with timings independent of each other, a readout timing is controlled in each group of columns. As such, it is possible to control the time for reading out signal electrical charges from the light receiving sections to the vertical transfer sections in each group of columns. Further, in n-phase drive (e.g., four-phase drive, six-phase drive), in which n gate electrodes make up one set of gate electrodes and the n gate electrodes are driven, it is possible, without limiting the number to n, to control the time for reading out from the vertical transfer sections to the horizontal transfer section in each group of columns, the direction for transferring signal electrical charges from the vertical transfer sections and the time for reading out signal electrical charges from the light receiving sections to the vertical transfer sections.

Various other modifications will be apparent to and can be readily made by those skilled in the art without departing from the scope and spirit of this invention. Accordingly, it is not intended that the scope of the claims appended hereto be limited to the description as set forth herein, but rather that the claims be broadly construed.

What is claimed is:

1. A solid-state image capturing device, comprising:
a plurality of light receiving sections, arranged in a matrix in an image capturing region, for photoelectrically converting received light into signal electrical charges;
signal readout sections for reading out the signal electrical charges from the light receiving sections;
vertical transfer sections driven by n-phase drive (n≧2, k is an integer greater than or equal to 2) in order to transfer the signal electrical charges, which have been read out from the light receiving sections in a column direction, in a vertical direction, wherein first-layer electrodes and second-layer electrodes are arranged in an alternating manner, and n electrodes make up one set of electrodes;
a horizontal transfer section for transferring the signal electrical charges, which have been transferred from the vertical transfer sections, in a horizontal direction,
wherein
the vertical transfer sections include first vertical transfer sections for transferring the signal electrical charges, which have been read out from the light receiving sections, in one direction or in an other direction and second vertical transfer sections for transferring the signal electrical charges in the one direction or the other direction with timings independent of those for the first vertical transfer sections.

2. A solid-state image capturing device according to claim 1, wherein a plurality of columns of light receiving sections having signal electrical charges to be read out to the first vertical transfer sections and a plurality of columns of light receiving sections having signal electrical charges to be read out to the second vertical transfer sections are arranged, and a direction for transferring the signal electrical charges is controlled in each group of columns.

3. A solid-state image capturing device according to claim 1, wherein the first vertical transfer sections and the second vertical transfer sections are arranged in each column in an alternating manner.

4. A solid-state image capturing device according to claim 2, wherein the first vertical transfer sections and the second vertical transfer sections are arranged in each column in an alternating manner.

5. A solid-state image capturing device according to claim 1, wherein the first vertical transfer sections and the second vertical transfer sections are arranged in every plurality of columns in an alternating manner.

6. A solid-state image capturing device according to claim 2, wherein the first vertical transfer sections and the second vertical transfer sections are arranged in every plurality of columns in an alternating manner.

7. A solid-state image capturing device according to claim 1, wherein the second-layer electrodes include first patterns for driving the first vertical transfer sections and second patterns for driving the second vertical transfer sections, and transfer control signals independent of each other are applied to the first patterns and the second patterns, respectively.

8. A solid-state image capturing device according to claim 1, wherein patterns of the first-layer electrodes are the same in a column direction, and first patterns and second patterns of the second-layer electrodes are different at the first vertical transfer sections and the second vertical transfer sections, respectively.

9. A solid-state image capturing device according to claim 7, wherein patterns of the first-layer electrodes are the same in a column direction, and first patterns and second patterns of the second-layer electrodes are different at the first vertical transfer sections and the second vertical transfer sections, respectively.

10. A solid-state image capturing device according to claim 1, wherein each of the first-layer electrodes is substantially strip-shaped and extends in a horizontal direction between adjacent light receiving sections of the plurality of light receiving sections, the first-layer electrode has patterns having a branched projection which extends in one of one direction and an other direction at each of the first vertical transfer sections and having a branched projection which extends in the other of the one direction and the other direction at each of the second vertical transfer sections,
each of the second-layer electrodes is substantially strip-shaped and extends in the horizontal direction between adjacent light receiving sections of the plurality of light receiving sections, the second-layer electrode includes a first pattern which extends in the other of the one direction and the other direction at the first vertical transfer section and which partially overlaps each of the branched projections of the first-layer electrode, and a second pattern which extends in the one of the one direction and the other direction at the second vertical transfer section and which partially overlaps each of the branched projections of the first-layer electrode.

11. A solid-state image capturing device according to claim 7, wherein each of the first-layer electrodes is substantially strip-shaped and extends in a horizontal direction between adjacent light receiving sections of the plurality of light receiving sections, the first-layer electrode has patterns having a branched projection which extends in one of one direction and an other direction at each of the first vertical transfer sections and having a branched projection which extends in the other of the one direction and the other direction at each of the second vertical transfer sections,
each of the second-layer electrodes is substantially strip-shaped and extends in the horizontal direction between adjacent light receiving sections of the plurality of light receiving sections, the second-layer electrode includes a first pattern which extends in the other of the one direction and the other direction at the first vertical transfer section and which partially overlaps each of the branched projections of the first-layer electrode, and a second pattern which extends in the one of the one direction and the other direction at the second vertical transfer section and which partially overlaps each of the branched projections of the first-layer electrode.

12. A solid-state image capturing device according to claim 7, wherein the first pattern is structured such that the width thereof is significantly narrower at the second vertical transfer section than at the first vertical transfer section so as not to influence a transfer of the signal electrical charges from the second vertical transfer section, and the second pattern is structured such that the width thereof is significantly narrower at the first vertical transfer section than at the second vertical transfer section so as not to influence a transfer of the signal electrical charges from the first vertical transfer section.

13. A solid-state image capturing device according to claim 8, wherein the first pattern is structured such that the width thereof is significantly narrower at the second vertical transfer section than at the first vertical transfer section so as not to influence a transfer of the signal electrical charges from the second vertical transfer section, and the second pattern is structured such that the width thereof is significantly narrower at the first vertical transfer section than at the second vertical transfer section so as not to influence a transfer of the signal electrical charges from the first vertical transfer section.

14. A solid-state image capturing device according to claim 10, wherein the first pattern is structured such that the width thereof is significantly narrower at the second vertical transfer section than at the first vertical transfer section so as not to influence a transfer of the signal electrical charges from the second vertical transfer section, and the second pattern is structured such that the width thereof is significantly narrower at the first vertical transfer section than at the second vertical transfer section so as not to influence a transfer of the signal electrical charges from the first vertical transfer section.

15. A solid-state image capturing device according to claim 1, further comprising:
a plurality of first signal readout sections, connected to the second-layer electrodes, for reading out the signal electrical charges from the light receiving sections in a first group of columns to the first vertical transfer sections; and
a plurality of second signal readout sections, connected to the second-layer electrodes, for reading out the signal electrical charges from the light receiving sections in a second group of columns other than the first group of columns to the second vertical transfer sections,
wherein
control signals independent of each other are applied to the signal readout sections, respectively, and a readout of the signal electrical charges from the plurality of light receiving sections to the vertical transfer sections is controlled in each group of columns.

16. A solid-state image capturing device according to claim 1, wherein the horizontal transfer section is arranged at one or both of one end and an other end of the image capturing region.

17. A solid-state image capturing device according to claim 1, wherein first-layer electrodes and second layer electrodes are repeatedly arranged in the horizontal transfer section.

18. A solid-state image capturing device according to claim 16, wherein first-layer electrodes and second layer electrodes are repeatedly arranged in the horizontal transfer section.

19. A solid-state image capturing device according to claim 1, wherein the first vertical transfer section and the second vertical transfer section each are arranged in each column in accordance with functions of the light receiving sections.

20. A solid-state image capturing device according to claim 2, wherein the first vertical transfer section and the second vertical transfer section each are arranged in each column in accordance with functions of the light receiving sections.

21. A solid-state image capturing device drive method for driving the solid-state image capturing device according to claim 1, comprising:
applying transfer control signals with same or different timings to the second-layer electrodes at the first vertical transfer sections and the second vertical transfer sections in order to control a transfer of signal electrical charges from the first vertical transfer sections and the second vertical transfer sections to the horizontal transfer section in each group of columns.

22. A solid-state image capturing device drive method for driving the solid-state image capturing device according to claim 15, comprising:
applying readout control signals to only one of the first signal readout sections and the second signal readout sections such that a readout of signal electrical charges from the light receiving sections to the first vertical transfer sections or the second vertical transfer sections is controlled in each group of columns and data in columns of the first vertical transfer sections or in columns of the second vertical transfer sections is decimated.

23. A solid-state image capturing device drive method for driving the solid-state image capturing device according to claim 15, comprising:
applying readout control signals to the first signal readout sections and the second signal readout sections with same or different timings such that a readout of signal electrical charges from the plurality of light receiving sections to the first vertical transfer sections and the second vertical transfer sections is controlled in each group of columns and data having a wide dynamic range is created by performing exposures on the plurality of light receiving sections in accordance with light portions and dark portions thereon and by combining two pieces of data.

24. An electronic information device using the solid-state image capturing device according to claim 1 for an image capturing section thereof.
